(19) United States
(12) Patent Application Publication
(10) Pub. No.: US 2025/0087747 A1
(43) Pub. Date: Mar. 13, 2025

(54) SOLID POLYMER ELECTROLYTES COMPRISING IONIC COMPOUNDS AND USES THEREOF

(71) Applicant: FUNDACIÓN CENTRO DE INVESTIGACIÓN COOPERATIVA DE ENERGÍAS ALTERNATIVAS CIC ENERGIGUNE FUNDAZIOA, Vitoria-Gasteiz, Álava (ES)

(72) Inventors: Michel ARMAND, Vitoria-Gasteiz, Álava (ES); Heng ZHANG, Vitoria-Gasteiz, Álava (ES); María MARTÍNEZ-IBÁÑEZ, Vitoria-Gasteiz, Álava (ES); Leire MEABE, Vitoria-Gasteiz, Álava (ES); Eduardo SÁNCHEZ DÍEZ, Vitoria-Gasteiz, Álava (ES); Javier CARRASCO RODRÍGUEZ, Vitoria-Gasteiz, Álava (ES); Alexander SANTIAGO, Vitoria-Gasteiz, Álava (ES)

(21) Appl. No.: 18/724,585

(22) PCT Filed: Dec. 23, 2022
(86) PCT No.: PCT/EP2022/087832

§ 371 Date: Jun. 26, 2024

(30) Foreign Application Priority Data
Dec. 27, 2021 (EP) 21383221.5

(51) Int. Cl. H01M 10/0565; C08K 5/43

(52) U.S. Cl. CPC H01M 10/0565; C08K 5/43; H01M 2220/20; H01M 2300/0082

(57) ABSTRACT

Solid state electrolytes having ionic compounds derived from sulfonimides have extended delocalization of the anionic charge and high total ionic conductivity. A secondary electrochemical cell or a secondary battery has the solid electrolyte. A vehicle, an electronic device, or an electrical grid comprising has at least one of the secondary electrochemical cell or the secondary battery.

### FIELD OF THE INVENTION

This invention relates to the field of electrochemistry. More particularly, the invention relates to a solid electrolyte comprising an ionic compound with highly delocalized negative charge for use in rechargeable batteries, especially lithium batteries.

### BACKGROUND

Electrolytes enable, according to their ionic conductivity, the movement of ions from the cathode to the anode on charge and in reverse on discharge. The electrolyte of a battery may consist of soluble salts, acids or other bases in liquid, gelled and dry formats. For example, it is well known that the salts of strong acids such as HClO₄, HBF₄, HPF₆ and HR_{F}SO₃ (R_{F}=perfluoroalkyl radical) have electrochemical properties. The “superacids” obtained by adding a Lewis acid such as SbF₅ to the abovementioned compounds are also known. However, these compounds are not stable other than in protonated form and in non-solvating media such as aliphatic hydrocarbons. The salts are unstable in the usual polar solvents.

Electrolytes can also be polymeric. The conductivity of polymer electrolytes, which is intrinsically low as they are primarily organic and contain ions only adventitiously in very small concentrations, may be increased by the addition of certain amounts of ionic compounds (or salts).

In particular, ionic compounds such as perfluorosulfonimide derivatives M[R_{F}SO₂NSO₂R_{F}](R_{F}=perfluoroalkyl) have recently raised more attention across various chemical fields. They have advantageous stability properties in protonated form (M is H) or in the form of salts (M is commonly a metal) and are used as solutes in electrochemistry and as catalysts. However, it is challenging to give these salts all desirable properties required for their applications, in particular in terms of properties such as acidity, dissociation ability or solubility. Among known M[R_{F}SO₂NSO₂R_{F}] derivatives, lithium bis(trifluoromethanesulfonyl)imide (Li[(CF₃SO₂)₂N], also abbreviated as LiTFSI, has been studied in recent years as a potential replacement of lithium hexafluorophosphate (LiPF₆), which currently dominates the landscape of ionic compounds for non-aqueous liquid electrolytes. LiTFSI is more chemically and thermally stable when compared to LiPF₆ and has already found application as conducting salt in aqueous electrolytes of lithium batteries having lithium metal as anode.

US2019/165417 A1 discloses compounds of general formula R¹—SO₂—N═S(O)R³—NM-SO₂—R² wherein R¹, R² and R³ each independently represent fluorine, an alkyl group having 1 to 6 carbon atoms or a fluoroalkyl group having 1 to 6 carbon atoms; and M+ represents an alkali metal ion. These compounds may be incorporated into solid electrolytes, however solid polymer electrolytes comprising them are not disclosed.

CN106674391A discloses an imine-polyanion lithium salt and a preparation method thereof as well as the application of the imine-polyanion lithium salt as non-aqueous electrolyte (such as in carbonate esters, ethers and ionic liquids). The non-aqueous electrolyte of the iamine-polyanion lithium salt can be used for a lithium ion battery or a secondary lithium battery, however not as a solid polymer electrolyte.

H. Zhang et al. (J. Power Sources 2015, 296, 142-149) report the physiochemical and electrochemical characterization of neat LisTFSI and its carbonated-based liquid electrolytes compared to LiPF₆, LiTFSI and (Li[(C₂F₅SO₂)₂N](abbreviated as LiBETI).

The liquid electrolyte is formed from LisTFSI in a mixture of ethylene carbonate (EC) and ethyl-methyl-carbonate (EMC) with small amounts of water. The ionic conductivity for LisTFSI was found to be smaller than that of LiTFSI, which is attributed to the larger anion volume of [sTFSI]⁻ compared to that of [TFSI]⁻.

H. Zhang et al. (ChemElectroChem 2021, 8, 1322-1328) disclose a LisTFSI/PEO (poly(ethylene oxide)) membrane that is characterized by a slightly superior Li⁺ ion only conductivity but again considerably lower total ionic conductivity compared to those of a standard LiTFSI/PEO solid electrolyte. Based on the higher dissociation ability of LisTFSI, a higher Li⁺ mobility was expected; however, these data reinforce the idea that the structural optimization of a conductive salt, especially in terms of its total conductivity, is not a trivial task. Indeed, the conditio sine qua non for a cell to undergo cycling and hence be of industrial relevance is a minimum value of total ionic conductivity.

U.S. Pat. No. 6,340,716B1 describes a wide range of ionic compounds that are useful for the production of ion conducting materials or electrolytes, as catalysts and for doping polymers, though this document does not point to a specific salt to couple to a solid electrolyte with the aim to improve the total electrolyte conductivity, given the excessive number of ionic compounds contemplated by the document and the multiple uses beyond the electrochemical field described therein.

In a review by Zhang Heng et al. (Chem. Soc. Rev. 2017, vol. 46(3), 797-815), the authors summarize the design and synthetic strategy of single lithium-ion conducting solid polymer electrolytes (SLIC-SPEs) with high ionic conductivity, current challenges and future perspectives in the field.

Finally, WO2021/023137A1 discloses lithium-ion batteries comprising a di-lithium salt with a —NLi—SO₂—NLi backbone.

Thus, there is still a need in the art for finding new ionic compounds for use in solid electrolytes that possess high ionic conductivity by carefully tuning the electronic properties of existing salts.

The aim of the present invention is to provide electrolytes comprising ionic compounds derived from sulfonimides in which the delocalization of the anionic charge is improved, thus resulting in markedly better acidity and dissociation than those of the known compounds, while at the same time retaining good stability and displaying higher total ionic conductivity by proper electronic modulation of the sulfonimides.

### BRIEF DESCRIPTION OF THE INVENTION

The inventors have surprisingly found that in incorporating a salt of formula I

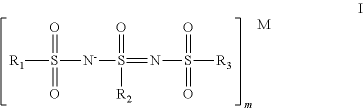

as defined elsewhere herein, which features high delocalization of the negative charge in the anion, into a solid electrolyte, preferably a solid polymer electrolyte, the total ionic conductivity of said solid polymer electrolyte is substantially increased. In particular, the anion of salt I involves an S—N—S—N—S core where sulfur atoms are hexavalent and the negative charge is delocalized between the two nitrogen atoms and the five oxygen atoms linked to the sulfur atoms; and specifically a fluorine atom directly attached to the S—N—S—N—S core at least at one of the substituents R₁, R₂ or R₃. It has unexpectedly been found that salts of this type lead to improved solid electrolytes that are more conductive than reported solid electrolytes comprising analogous salts with no fluorine substituents linked to any of the sulfur atoms.

Therefore, in a first aspect, the present invention refers to a solid electrolyte, preferably solid polymer electrolyte comprising a compound of formula I

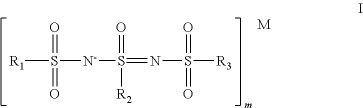

wherein
M is:
   a proton;
   a metal cation having a valency equal to 1, 2 or 3, chosen from ions of alkali metals, of alkaline earth metals, of transition metals or of rare-earth metals;
   an organic onium or polyonium cation;
   an organometallic cation;
m is an integer positive number; and
at least one of the groups R₁, R₂ or R₃ is F and the remainder is independently selected from:
   —Y, wherein Y represents:
      an organic radical chosen from alkyl, alkenyl, alkynyl, aryl, alkylaryl, arylalkyl, alkylene oxide or alkylene imine, optionally substituted with at least a substituent selected from the group consisting of F, Cl, Br, I, —CN, —OR′, —SR′, —NR′₂, wherein R′ is H, alkyl, alkylene oxide or alkylene imine; or
      a polymeric group comprising repeating units selected from alkylene oxide, alkylene imine, styrene, acrylate, maleimide, phosphazene, siloxane, vinyl alcohol, vinyl amine or mixtures thereof;
   —OY, —SY, —NY₂, wherein Y represents:
      H or an organic radical chosen from alkyl, alkenyl, alkynyl, aryl, alkylaryl, arylalkyl, alkylene oxide or alkylene imine, optionally substituted with at least a substituent selected from the group consisting of F, Cl, Br, I, —CN, —OR′, —SR′, —NR′₂, wherein R′ is H, alkyl, alkylene oxide or alkylene imine; or
      a polymeric group comprising repeating units selected from alkylene oxide, alkylene imine, styrene, acrylate, maleimide, phosphazene, siloxane, vinyl alcohol, vinyl amine or mixtures thereof.

In another aspect, the invention refers to a secondary electrochemical cell or a secondary battery comprising the solid electrolyte, preferably solid polymer electrolyte according to the first aspect of the invention.

In a third aspect, the invention refers to a vehicle, electronic device or electrical grid comprising at least one electrochemical cell or battery according to the first aspect of the invention.

### BRIEF DESCRIPTION OF DRAWINGS

FIG. 1 shows the Arrhenius plot of ionic conductivity of Li salt/PEO electrolytes.

### DETAILED DESCRIPTION OF THE INVENTION

The present invention refers to a solid electrolyte, preferably solid polymer electrolyte, comprising an ionic compound of formula I

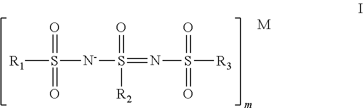

wherein
M is:
   a proton;
   a metal cation having a valency equal to 1, 2 or 3, chosen from ions of alkali metals, of alkaline earth metals, of transition metals or of rare-earth metals;
   an organic onium or polyonium cation;
   an organometallic cation;
m is an integer positive number; and
at least one of the groups R₁, R₂ or R₃ is F and the remainder is independently selected from —Y, wherein Y represents:
   an organic radical chosen from alkyl, alkenyl, alkynyl, aryl, alkylaryl, arylalkyl, alkylene oxide or alkylene imine, optionally substituted with at least a substituent selected from the group consisting of F, Cl, Br, I, —CN, —OR′, —SR′, —NR′₂, wherein R′ is H, alkyl, alkylene oxide or alkylene imine; or
   a polymeric group comprising repeating units selected from alkylene oxide, alkylene imine, styrene, acrylate, maleimide, phosphazene, siloxane, vinyl alcohol, vinyl amine or mixtures thereof;
—OY, —SY, —NY₂, wherein Y represents:
   H or an organic radical chosen from alkyl, alkenyl, alkynyl, aryl, alkylaryl, arylalkyl, alkylene oxide or alkylene imine, optionally substituted with at least a substituent selected from the group consisting of F, Cl, Br, I, —CN, —OR′, —SR′, —NR′₂, wherein R′ is H, alkyl, alkylene oxide or alkylene imine; or
   a polymeric group comprising repeating units selected from alkylene oxide, alkylene imine, styrene, acrylate, maleimide, phosphazene, siloxane, vinyl alcohol, vinyl amine or mixtures thereof.

The subscript “m” is an integer positive number that refers to the number of anions needed to neutralize the charge of the cation M.

The term “alkyl radical” refers to an alkane-derived radical which is bound to the rest of the molecule through a single bond. It may be linear or branched. It preferably comprises from 1 to 16 (“C₁-C₁₆ alkyl”), preferably from 1 to 8 (“C₁-C₅ alkyl”), even more preferably from 1 to 4 (“C₁-C₄ alkyl”) carbon atoms. Illustrative examples of alkyl groups include methyl, ethyl, n-propyl, i-propyl, n-butyl, i-butyl, t-butyl, pentyl, hexyl, heptyl, octyl.

The term “aryl radical” refers to an aromatic group, preferably having between 6 and 10 carbon atoms (“C₆-C₁₀ aryl”), which may comprise 1 aromatic ring or 2 aromatic rings fused to one another. Illustrative examples of aryl groups include phenyl, naphthyl or indenyl. Preferably, it is phenyl.

The term “alkenyl radical” refers to an alkene-derived radical which is bound to the rest of the molecule through a single bond. It may be linear or branched. It preferably comprises from 2 to 16 (“C₂-C₁₆ alkenyl”), preferably from 2 to 8 (“C₂-C₅ alkenyl”), even more preferably from 2 to 4 (“C₂-C₄ alkenyl”) carbon atoms.

The term “alkynyl radical” refers to an alkyne derived radical which is bound to the rest of the molecule through a single bond. It may be linear or branched. It preferably comprises from 2 to 16 (“C₂-C₁₆ alkynyl”), preferably from 2 to 8 (“C₂-C₅ alkynyl”), even more preferably from 2 to 4 (“C₂-C₄ alkynyl”) carbon atoms.

The term “alkylaryl radical” refers to a radical derived from a group comprising an alkyl as defined above bearing at least an aryl group as described above along the alkyl chain and which is bound to the rest of the molecule through the alkyl group.

The term “arylalkyl radical” refers to a radical derived from a group comprising an alkyl as defined above bearing at least an aryl group as described above along the alkyl chain and which is bound to the rest of the molecule through the aryl group.

In an embodiment, when double substitution at an amine nitrogen with a same given group is indicated, such as Y₂ or R₂ or R′₂, each of the two substituents is selected independently from the other. In another embodiment, said substituents are the same.

The term “alkylene oxide radical” refers to a radical derived from a saturated aliphatic chain containing alkylene oxide units which is bound to rest of the molecule through a single bond. It may be linear or branched. The alkylene portion refers to an alkane-derived diradical. The term “alkylene” is generally employed as meaning non-terminal alkyl moieties. The alkylene oxide radical can be depicted through general formula -(alkylene-O)ₓRₐₒ, wherein x is from 1 to 5, more preferably 1 or 2; the alkylene portion comprises from 1 to 16 (“C₁-C₁₆ alkylene”), preferably from 1 to 8 (“C₁-C₈ alkylene”), even more preferably from 1 to 4 (“C₁-C₄ alkylene”) carbon atoms; and Rₐₒ is H or alkyl as described above, preferably H or methyl, more preferably H. Preferably, the alkylene oxide units are ethylene or propylene oxide units, namely —(CH₂CH₂O)ₓRₐₒ or —(CH₂CH₂CH₂O)ₓRₐₒ, wherein x and Rₐₒ are as described above. Most preferably, the alkylene oxide units are such ethylene oxide units.

The term “alkylene imine” refers to a radical derived from a saturated aliphatic chain containing alkylene imine units which is bound to rest of the molecule through a single bond. It may be linear or branched. The alkylene portion refers to an alkane-derived diradical. The alkylene oxide radical can be depicted through general formula -(alkylene-NH)ₓRₐₒ, wherein x is from 1 to 5, more preferably 1 or 2; the alkylene portion comprises from 1 to 16 (“C₁-C₁₆ alkylene”), preferably from 1 to 8 (“C₁-C₈ alkylene”), even more preferably from 1 to 4 (“C₁-C₄ alkylene”) carbon atoms; and Rₐₒ is H or alkyl as described above, preferably H or methyl, more preferably H. Preferably, the alkylene imine units are ethylene or propylene imine units, namely —(CH₂CH₂NH)ₓRₐₒ or —(CH₂CH₂CH₂NH)ₓRₐₒ, wherein x and Rₐₒ are as described above. Most preferably, the alkylene imine units are such ethylene imine units. The N—H group may also be substituted by an N-alkyl group, wherein alkyl has the meaning described above.

The term “polyonium” refers to a polycation comprising two or more organic onium cations as described below which are preferably connected intramolecularly by organic linkers, such as those comprising 1 to 8 carbons, such as C₁-C₈ alkylene, e.g. methylene, ethylene, propylene or butylene. The molecular structure of polyonium cations used in the present invention can be, without being limited thereto, a linear-chain structure, branched structure, and ring-shaped structure. Examples of polyonium include polyammonium, polyphosphonium, polypyridinium, polypyrrolidonium, polyimidazolium, polyimidazolinium and polysulfonium cations. In an embodiment, the polyonium comprises at least 10 onium cations, such as at least 100 or at least 1000 onium cations. In an embodiment, the polyonium comprises up to 3000 onium cations.

### Ionic Compound and Preparation Thereof

In the context of the invention the terms “ionic compound” and “salt” will be used interchangeably. The ionic compounds incorporated in the solid electrolyte, preferably solid polymer electrolyte, of the invention comprise a cation M and an anion of formula

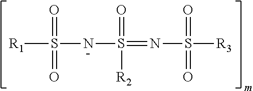

wherein the subscript “m” is a positive integer number that refers to the number of anions needed to neutralize the charge of the cation M. The negative charge in the anion is represented for the sake of illustration on one nitrogen atom, however, it is a delocalized negative charge that is distributed due to resonance over the two nitrogen atoms and the five oxygen atoms in the anion of the general formula I. The ionic compounds of formula I can be prepared following the procedure detailed in the examples of the present disclosure. In particular, the synthesis is performed in a one-pot fashion by reaction of a sulfonamide salt with a N-(sulfinyl)sulfonamide and subsequent oxidation with an electrophilic source. More specifically, a sulfonamide dipotassium salt R₃SO₂NK₂ such as CF₃SO₂NK₂ is reacted with an N-(sulfinyl)sulphonamide R₁SO₂N═S═O, such as N-(sulfinyl)trifluoromethanesulfonamide, CF₃SO₂N═S═O, to generate a dianionic sulfinate, S(IV), intermediate, which is oxidized in situ to the corresponding sulfonate, S(VI), such as the fluorinated sulfonate when 1-chloromethyl-4-fluoro-1,4-diazoniabicyclo[2.2.2]octane bis(tetrafluoroborate) (F-TEDA) is employed as electrophilic fluorine source.

Precursors of formula R₃SO₂NK₂ can be obtained by reaction of R₃SO₂NH₂ with a base in an aprotic solvent. Examples of suitable bases include an alkali or alkaline earth metal hydroxide, alkoxide, carbonate, hydride, amide such as sodium hydroxide, potassium hydroxide, sodium methoxide, sodium ethoxide, potassium tert-butoxide, sodium carbonate, potassium carbonate, cesium carbonate or potassium hydride, while examples of suitable aprotic solvents include THF, diethyl ether, methyl tert butyl ether (MTBE), 1,4-dioxane, MeTHF, acetonitrile, dichloromethane, ethyl acetate nitrobenzene, 1,2-dichloroethane or mixtures thereof. Compounds of formula R₁SO₂N═S═O can be obtained by reaction of R₁SO₂NH₂ with SOCl₂ according to known procedures (J. Chem. Soc., Perkin Trans. 1, 2002, 1887-1889 and references cited therein). The same compound R₃SO₂NH₂, optionally in presence of a base (any non-nucleophilic bases, as tertiary amines, amides of alkali and alkaline earth metals or organometallic compounds), can be used to react with R₁SO₂N═S═O. Starting materials R₃SO₂NH₂ and R₁SO₂NH₂ (such as alkyl, aryl, and alkylaryl sulphonamides) or sulfonyl chlorides are commercially available are widely commercially available from different chemical vendors such as Sigma-Aldrich. Additionally, chlorosulfonyl isocyanate is a widely used precursor for the preparation of sulfonamides R₃SO₂NH₂ and R₁SO₂NH₂ when reacted with nuclepophiles as alcohols and further hydrolysis to turn isocyanate group into NH₂ (see DOI:10.1002/0470034394, chapter 22, pages 1007-1008). Alternatively, R₃SO₂NH₂ and R₁SO₂NH₂ can be obtained by the treatment of sulfonyl chloride precursors, e.g. R₃SO₂C₁ and R₁SO₂C₁, or surrogates with ammonia, either gas or aqueous solution. Sultones and sultams can be used as sulfonyl chloride surrogates to include alkylene oxide and alkylene imine in different ways (see DOI:10.1002/0470034394, chapter 19). The strategies include a) using a sultone/sultam already containing the alkylene oxide/alkylene imine moiety or in a more general way ether/amine moieties in the sultone/sultam ring (see DOI:10.1002/0470034394, chapter 19, page 855), b) hydrolysis/ammonolysis of sultones/sultams to include the oxygen/nitrogen of alkylene/alkylene imine moiety (see DOI:10.1002/0470034394, chapter 19, pages 819 and 862), c) addition of aliphatic nucleophiles (see DOI:10.1002/0470034394, chapter 19, pages 835-836) bearing the desired alkylene/alkylene imine moiety. Compounds like 1,3-propane sultone and propane sultam are commercially available reagents. Alkynyl derivatives can be prepared from corresponding sulfonyl chloride precursors (a) via ammonolysis of commercial alkynyl sulfonyl chlorides, e.g. CAS: 64099-81-6 available from Merck; b) via addition of Grignard reagents to sulfuryl chloride (see WO2010038465 A1). In the particular case of R₁ o R₃ equal to OY, SY and NY₂ and Y═H, the alcohol, thiol or amine can be protected prior to avoid any undesired reactions of the sulfinyl sulfonamide, and then deprotected after obtaining compound of Formula I. An easy approach to get the sulfonamides would be to react sulfamoyl chloride with the corresponding protected alcohol, thiol or amine.

The reaction between the N-(sulfinyl)sulfonamide R₁SO₂N═S═O and the sulphonamide R₃SO₂NK₂ is performed by adding R₁SO₂N═S═O dissolved in a suitable organic solvent to a suspension of R₃SO₂NK₂ suspended in the same or in a different organic solvent.

Particularly, the organic solvent is the same. Suitable solvents, both for the dissolution and for the suspension, are aprotic polar solvents such as THF, diethyl ether, methyl tert butyl ether (MTBE), dioxane, MeTHF, acetonitrile, dichloromethane, ethyl acetate or a combination thereof. Particularly, the solvent is a combination of THF with any of the aprotic polar solvents above. Even more particularly the solvent is THF. The resulting mixture is let to react until complete conversion, typically for 20 minutes to 10 hours, more particularly for 1 hour.

The obtained compound is a dianionic sulfinate intermediate wherein the central sulfur atom has an oxidation state of (IV), thus rendering said intermediate compound a versatile synthon for oxidation reactions. Indeed, the dianionic sulfinate can react with a number of electrophilic species to afford the corresponding ionic compounds of the invention where the central sulfur atom is in its highest oxidation state, S(VI). The ionic compounds can be isolated, purified and then used in subsequent steps.

Particularly, the two steps are performed in a one-pot manner. In this case, a purification step of the dianionic sulfinate intermediate is avoided, thus rendering the overall process less time-consuming and wasteful.

Typical reagents suitable to react with compound IV are fluorinating reagents, i.e., source of electrophilic fluorine, such as 1-Chloromethyl-4-fluoro-1,4-diazoniabicyclo[2.2.2]octane bis(tetrafluoroborate) (also known as F-TEDA or selectfluor), N-fluorobenzenesulfonimides, such as N-Fluorobenzenesulfonimide (NFSI) and fluoropyridinium salts, such as N-fluoropyridinium triflate; bromination reagents, such as N-Bromosuccinimide (NBS); chlorination reagents, such as N-Chlorosuccinimide (NCS); iodination reagents as N-Iodosuccinimide (NIS); alkylating reagents such as iodoalkanes (e.g. iodomethane), alkyl triflates (e.g. methyl triflate), trimethyloxonium tetrafluoroborate, alkyl bromides (e.g. CH₃BR, CH₂CH₃Br); trifluoromethylation and perfluoroalkylaion reagents, source of electrophilic —CF₃ and perfluoroalkyl (Chem. Commun., 2016, 52, 4049-4052) radicals, respectively, such as Togni reagents (I and II), Langlois reagent (CF₃SO₂Na), Umemoto's reagent; aminating reagents, such as chloramines.

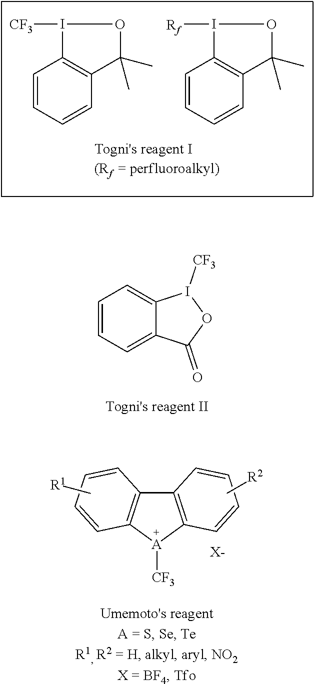

Particularly, the reagent added to the S(IV) intermediate is a reagent selected from F-TEDA, NFSI, N-fluoropyridinium triflate, NBS, NCS, NIS, or a trifluoromethylation reagent selected from Togni reagents (I and II), Langlois reagent (CF₃SO₂Na) and Umemoto's reagent. More particularly is F-TEDA. Particularly, said reagent is added neat. Particularly, said reagent is first dissolved in an organic solvent or in a mixture of organic solvents and then added to the solution of of the dianionic sulfinate intermediate obtained as describe above. Alternatively, an organic solvent or a mixture of organic solvents is first added to the solution of the dianionic sulfinate intermediate, then the electrophilic reagent is added. Particularly, a mixture of THF and HFIP (hexafluoro-2-propanol) is first added to the solution of dianionic sulfinate intermediate, then the electrophilic reagent is added. Particularly the ratio THF:HFIP is comprised between 10:1 to 1:10. Particularly, the reaction is let to react for 30 min to 48 hours until completion, particularly for 1 to 6 hours.

The obtained ionic compound of formula I is subjected to purification. This step ensures the separation of said ionic compound from possible by-products in the reaction medium. Particularly, the purification of the ionic compound of formula (I) is performed by firstly evaporating the solvent and then extracting with aqueous acid and organic solvent. Solvent evaporation can be performed by several techniques known to the person skilled in the art, for example by heating up the solution to a suitable temperature, applying reduced pressure or by a combination of heating and reduced pressure. A skilled person would be able to find the optimal pressure and temperature values for the evaporation of the solvent. Particularly, the extraction with aqueous acid and organic solvent is performed at least one time, at least two times or at least three times. Particularly, the collected organic fractions from the at least one, at least two or at least three extractions is removed under reduced pressure.

The ionic compound of formula I can be subjected to an additional cation exchange step. For example, the cation exchange step can be performed with a lithium salt if a ionic compound with a lithium cation is desired. The cation exchange step can be carried out by widely known methods such as that described for example in Zhang et al, Angew. Chem., 2019, 131, 7911-7916.

The described method optionally comprises an additional step which allows functional group interconversion to access other desired ionic compounds of formula (I) starting from the route as described herein above. Halogen atoms, such as fluorine atoms, at R₁, R₂ or R₃ position in the general formula I can be replaced, for example, by other nucleophiles by nucleophilic substitution reactions as taught in the textbook “The Chemistry of Sulfonic Acids, Esters, and Their Derivatives” (DOI: 10.1002/0470034394, chapters 11, 21 and 22). More particularly, said fluorine atoms can be replaced by an alkyl or aminoalkyl radical, by reacting said salt of formula (I) with an alkylation reagent or an amination reagent. Nucleophilic hydrocarbons (e.g. TMS-alkanes) reacting with chlorosulfonic halosulfonic acid derivatives to afford sulphamic acid derivatives belong to common general knowledge. Additionally, O—, S- and N-containing compounds could also act as nucleophiles and a skilled person would routinely use them to replace a halide and obtain O—, S- and N-substituted products. The nucleophilic substitution is carried out under basic conditions and by heating the reaction mixture. Particularly, the nucleophile is an alkyl nucleophile or an amine nucleophile which is used in at least 2-fold excess compared to the ionic compound and the solvent is a polar, non-electrophilic solvent selected from dichloromethane, THF, diethyl ether and acetonitrile. The starting fluoride (R₁, R₂ or R₃=F) would be equivalent to a sulfonyl halide, to a halosulfonic acid derivative, or to a sulphamic acid derivative. The reactivity of these compounds is well known and described in textbooks, such as “The Chemistry of Sulfonic Acids, Esters, and Their Derivatives” (DOI: 10.1002/0470034394, Chapters 11, 21 and 22). Electron-withdrawing groups attached to the sulfur (VI) bearing the halogen would make it more reactive to nucleophilic attack, so it would be possible to substitute a fluoride, and equally possible a bromide or chloride, by another nucleophile.

Further derivatizations can be foreseen and a person skilled in the art familiar with functional group interconversion would be able to carry out to access other desired ionic compounds starting from the route described herein.

### Cation

The cation M can be a proton or a number of organic, organometallic and inorganic species that are able to carry one or more positive charges. However, in a preferred embodiment, in any embodiment described herein, M does not include the proton, and more particularly it is:
a metal cation having a valency equal to 1, 2 or 3, chosen from ions of alkali metals, of alkaline earth metals, of transition metals or of rare-earth metals;
an organic onium or polyonium cation;
an organometallic cation.

In a preferred embodiment, M is an alkali metal, that is, a metal of the group 1 of the periodic table that forms a monovalent cation M⁺. In a preferred embodiment, M is an alkali metal chosen from Li⁺, Na⁺, K⁺ and Cs⁺. More preferred alkali metals are Li⁺, Na⁺ and K⁺. Even more preferably, the alkali metal is Li⁺.

In another embodiment, M is an alkaline earth metal, that is, a metal of the group 2 of the periodic table that forms a divalent metal cation M²⁺. In a preferred embodiment, the alkaline earth metal is selected from Mg²⁺, Ca²⁺ and Ba²⁺.

In another embodiment, M is a transition metal with a valency comprised between 1 and 3. In a preferred embodiment, M is a transition metal selected from the group consisting of Cu²⁺, Zn²⁺, Fe²⁺ and Re³⁺.

In another embodiment, M is a rare-earth metal.

In a preferred embodiment, the cation M is selected from the group of metal cations consisting of K⁺, Li⁺, Na⁺, Cs²⁺, Mg²⁺, Ca²⁺, Ba²⁺, Cu²⁺, Zn²⁺, Fe²⁺, or Re³⁺.

In another embodiment, the cation M is an organic onium cation, namely a cation obtained by the protonation of a mononuclear hydride of a pnictogen (group 15 of the periodic table), chalcogen (group 16), or halogen (group 17) atom; or a derivative thereof wherein at least one H radical is replaced with a C₁-C₈ alkyl, a C₆-C₁₀ aryl or a heteroaryl radical. Examples of group 15 onium cations are ammonium (NH₄⁺), phosphonium (PH₄⁺) and arsonium (AsH₄⁺). Preferred organic onium cations are nitrogen-comprising onium cations such as pyrrolidinium, imidazolium, imidazolinium ions. The terms “C₁-C₈ alkyl” and “C₆-C₁₀ aryl” have the meaning described above. The term “heteroaryl” refers to an aromatic monocyclic or bicyclic system containing from 5 to 10 ring atoms containing one or more, specifically one, two or three ring heteroatoms independently selected from O, N and S, and the remaining ring atoms being carbon.

In another embodiment, the cation M is an organometallic cation which can be chosen from metalloceniums. For example, mention may be made of the cations derived from ferrocene (i.e. ferrocenium ion), from titanocene, from zirconocene, from an indocenium or from an arene metallocenium. It can also be chosen from metal cations coordinated by atoms such as O, S, Se, N, P or As, borne by organic molecules, in particular in the form of carbonyl, phosphine or porphyrine ligands optionally containing chirality. M can also be a metal cation bearing alkyl groups, such as those containing from 1 to 10 carbon atoms, for example a trialkylsilyl or dialkylstannyl derivative; in this case, M is linked to the anion [R₁—S(O)₂—N—S(O)(R₂)—N—S(O)₂—R₃] via a very labile covalent bond and the compound behaves like a salt. The cation M can also be the cationic oxidized form of methylzinc, phenylmercury, trialkyltin or trialkyllead (wherein alkyl means “C₁-C₈ alkyl” as defined above), chloro[ethylenebis(indenyl)]zirconium(IV) or tetrakis-(acetonitrile)palladium(II) cations.

In a particularly preferred embodiment, the cation M is a polyonium cation. In a preferred embodiment the polyonium cation is a polyammonium, polypyrrolidonium, polyimidazolium, polyimidazolinium cation, preferably a polyammonium, polyimidazolium, or polyimidazolinium cation.

In a preferred embodiment, the polypyrrolidonium cation has the following general formula:

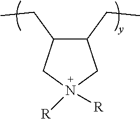

wherein each R is independently alkyl, alkenyl, aryl, or alkylene oxide, wherein these terms have the meaning described above; and wherein y denotes the number of repeating onium ion units comprised in the polyonium. Preferably, the alkyl and alkenyl are respectively a C₁-C₁₂ alkyl and a C₂-C₁₂ alkenyl. Preferably, the alkylene oxide is ethylene oxide or propylene oxide; preferably in the alkylene oxide x is 2, even more preferably x is 1. In a preferred embodiment, the polypyrrolidonium cation is polyDADMA, that is polydiallyldimethylammonium.

In another preferred embodiment, the polyimidazolium cation is one wherein the imidazolium cations do not form part of the polyimidazolium backbone, but are rather comprised in sidechains thereof.

In a particular embodiment, the polyimidazolium cation may have one of the following general formulas:

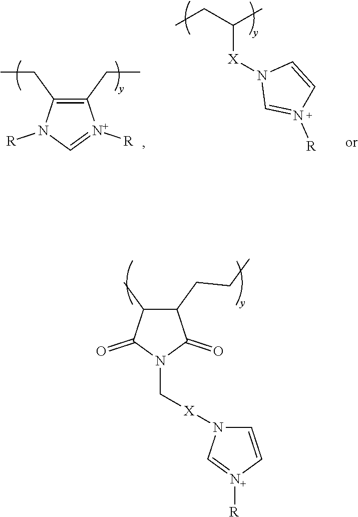

where each R is independently alkyl, alkenyl, aryl, or alkylene oxide, wherein these terms have the meaning described above; X is a spacer corresponding to an alkylene (preferably a C₁-C₆ alkylene), a phenylene (—C₆H₄— optionally with ortho, meta or para substitution on the aromatic ring) or a —C(═O)O— group; and y denotes the number of repeating onium ion units comprised in the polyonium. Preferably, the polyimidazolium cation is

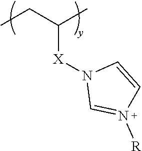

Wherein R, X and y are defined as above.

In another preferred embodiment, the polyimidazolinium cation is selected from one of the following structures:

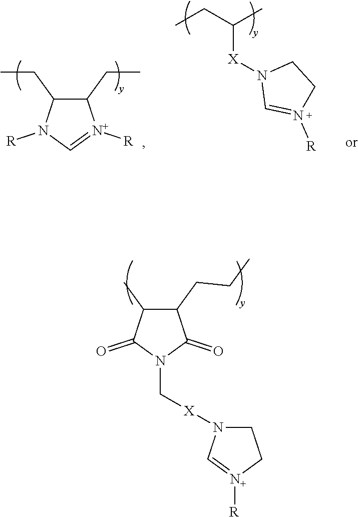

wherein each R, X and y are defined as above for polyimidazoliums.

In a preferred embodiment, the solid electrolyte of the invention comprises the ionic compound of formula I, wherein M is proton, Li⁺, Na⁺, K⁺ or a polyonium cation. In an embodiment, M is Li⁺. In another embodiment, M is a polyonium cation.

### Anion

The anion has three R fragments, R₁, R₂ and R₃, which can be independently selected from a variety of groups, but wherein at least one of R₁, R₂ or R₃ must be F. Extending the delocalization of the typical TFSI anion through the inclusion of an additional —SO₂R unit increases the anion size in the salt which might intuitively imply a loss of total ionic conductivity. The inventors have surprisingly found that the presence of at least one fluorine atom at any of the R₁, R₂ or R₃ substituents surprisingly results in an increase in the total ionic conductivity compared to electrolytes with smaller or comparable anionic volume wherein no F atom is found at least at a R₁, R₂ or R₃ group.

In a preferred embodiment, the solid electrolyte, preferably solid polymer electrolyte of the invention comprises the ionic compound of formula I, wherein Y represents an organic radical as defined above. In a more preferred embodiment, the organic radical is optionally substituted with at least one F, Cl, Br or I. More preferably, the organic radical is optionally fluorinated or perfluorinated, i.e. the H atoms at any aliphatic chain or aromatic ring present in the radical are partially or completely substituted by F atoms. In an embodiment, the organic radical is fluorinated or perfluorinated.

In a preferred embodiment, the solid electrolyte, preferably solid polymer electrolyte of the invention comprises the ionic compound of formula I, wherein at least one of the groups R₁, R₂ or R₃ is F and the remainder is independently selected from —Y, wherein Y is as described elsewhere herein. More preferably, at least one of the groups R₁, R₂ or R₃ is F and the remainder is independently selected from —Y, wherein Y represents an organic radical chosen from fluorinated or perfluorinated alkyl, alkenyl, alkynyl, aryl, alkylaryl, arylalkyl, alkylene oxide or alkylene imine, and more preferably Y represents an organic radical chosen from fluorinated or perfluorinated alkyl.

In a preferred embodiment, the solid electrolyte, preferably solid polymer electrolyte of the invention comprises the ionic compound of formula I, wherein at least one of the groups R₁, R₂ or R₃ is F and the remainder is independently selected from —OY, —SY, —NY₂, preferably from —OY and/or —NY₂, wherein Y is as described elsewhere herein. More preferably, Y is alkyl, alkenyl, alkynyl or alkylene oxide.

In a preferred embodiment, the solid electrolyte, preferably solid polymer electrolyte of the invention comprises the ionic compound of formula I, wherein at least one of the groups R₁, R₂ or R₃ is F and the remainder is independently selected from —Y, —OY, —SY, —NY₂, wherein Y for —Y is chosen from fluorinated or perfluorinated alkyl, alkenyl, alkynyl, aryl, alkylaryl, arylalkyl, alkylene oxide or alkylene imine, and more preferably chosen from fluorinated or perfluorinated alkyl; and Y for —OY, —SY, —NY₂ is alkyl, alkenyl, alkynyl or alkylene oxide.

In a preferred embodiment, the solid electrolyte, preferably solid polymer electrolyte of the invention comprises the ionic compound of formula I, wherein:
when Y is alkyl, then it is fluorinated or perfluorinated; or particularly
when Y is alkyl, alkenyl, alkynyl, then it is fluorinated or perfluorinated; or more particularly
when Y is alkyl, alkenyl, alkynyl, aryl, alkylaryl, arylalkyl, alkylene oxide or alkylene imine, then it is fluorinated or perfluorinated.

In a preferred embodiment, the solid electrolyte, preferably solid polymer electrolyte of the invention comprises the ionic compound of formula I, wherein:
when Y in any —Y group is alkyl, then it is fluorinated or perfluorinated; or particularly
when Y in any —Y group is alkyl, alkenyl, alkynyl, then it is fluorinated or perfluorinated; or more particularly;
when Y in any —Y group is alkyl, alkenyl, alkynyl, aryl, alkylaryl, arylalkyl, alkylene oxide or alkylene imine, then it is fluorinated or perfluorinated.

In a most preferred embodiment, in any of the embodiments disclosed herein, the solid electrolyte, preferably solid polymer electrolyte of the invention comprises the ionic compound of formula I, wherein R₂ is F.

In a more particular embodiment, R₂ is F and:
when Y is alkyl, then it is fluorinated or perfluorinated; or particularly
when Y is alkyl, alkenyl, alkynyl, then it is fluorinated or perfluorinated; or more particularly;
when Y is alkyl, alkenyl, alkynyl, aryl, alkylaryl, arylalkyl, alkylene oxide or alkylene imine, then it is fluorinated or perfluorinated.

In a more particular embodiment, R₂ is F and:
when Y in any —Y group at R₁ and R₃ is alkyl, then it is fluorinated or perfluorinated;
or particularly
when Y in any —Y group at R₁ and R₃ is alkyl, alkenyl, alkynyl, then it is fluorinated or perfluorinated; or more particularly;
when Y in any —Y group at R₁ and R₃ is alkyl, alkenyl, alkynyl, aryl, alkylaryl, arylalkyl, alkylene oxide or alkylene imine, then it is fluorinated or perfluorinated.

In an embodiment, in the ionic compound of formula I as defined above, Y groups are optionally substituted. In another embodiment, they are substituted. Substitution is preferably at any aliphatic or aromatic C—H bond present in the organic radical.

In a specific embodiment, each Y independently represents an alkyl radical as described above which is fluorinated or perfluorinated, more preferably an alkyl radical comprising from 1 to 4 carbon atoms which is fluorinated or perfluorinated, even more preferably Y represents CF₃.

In a more specific embodiment, at least one of R₁, R₂ or R₃ is F and Y at any —Y group at the remainder of R₁, R₂ or R₃ is independently selected from alkyl, alkenyl, alkynyl, aryl, alkylaryl, arylalkyl, alkylene oxide or alkylene imine, optionally substituted with at least a substituent selected from the group consisting of F, Cl, Br, I, —CN, —OR′, —SR′, —NR′₂, wherein each R′ is independently selected from H, alkyl, alkylene oxide, alkylene imine. In a more specific embodiment, at least one of R₁, R₂ or R₃ is F and Y at any —Y group at the remainder of R₁, R₂ or R₃ is independently selected from an alkyl radical which is fluorinated or perfluorinated, more preferably an alkyl radical comprising from 1 to 4 carbon atoms which is fluorinated or perfluorinated, even more preferably Y represents CF₃. In a more specific embodiment, at least one of R₁, R₂ or R₃ is F and the remainder of R₁, R₂ or R₃ is independently selected from —Y, wherein Y is an alkyl radical which is fluorinated or perfluorinated, more preferably an alkyl radical comprising from 1 to 4 carbon atoms which is fluorinated or perfluorinated, even more preferably Y represents CF₃.

In a more specific embodiment, R₂ is F and R₁ and R₃ are each independently from alkyl, alkenyl, alkynyl, aryl, alkylaryl, arylalkyl, alkylene oxide or alkylene imine, optionally substituted with at least a substituent selected from the group consisting of F, Cl, Br, I, —CN, —OR′, —SR′, —NR′₂, wherein each R′ is independently selected from H, alkyl, alkylene oxide, alkylene imine or R₁ or R₃ is F and the remainder of R₁, R₂ or R₃ is independently selected from alkyl, alkenyl, alkynyl, aryl, alkylaryl, arylalkyl, alkylene oxide or alkylene imine, optionally substituted with at least a substituent selected from the group consisting of F, Cl, Br, I, —CN, —OR′, —SR′, —NR′₂, wherein each R′ is independently selected from H, alkyl, alkylene oxide, alkylene imine.

In an even more specific embodiment, R₂ is F and R₁ and R₃ are each independently from alkyl, aryl, alkylaryl, arylalkyl, alkylene oxide or alkylene imine, optionally substituted with at least a substituent selected from the group consisting of F, Cl, Br, I, —CN, —OR′, —SR′, —NR′₂, wherein each R′ is independently selected from H, alkyl, alkylene oxide, alkylene imine.

In an even more specific embodiment, R₂ is F and R₁ and R₃ are each independently an alkyl radical which is fluorinated or perfluorinated, more preferably an alkyl radical comprising from 1 to 4 carbon atoms which is fluorinated or perfluorinated, even more preferably CF₃. In a very preferred embodiment, R₂ is F and R₁ and R₃ are CF₃. Examples of perfluorinated radicals Y are —CF₃, —CF₂CF₃, —CF₂(CF₂)ₙCF₃ (n=1 to 7), —CF(CF₃)₂, —CF₂CF(CF₃)₂, —CF(CF₃)(CF₂)ₙCF₃ (n=1 to 5), —CF₂CF(CF₃)(CF₂)ₙCF₃ (n=1 to 4). —CF═CF₂, —CF═CFCF₃, —CF₂CF═CF₂, —CF═C(CF₃)₂, —CF═CFCF₂CF₃, —CF₂CF═CF₂CF₃, —CF₂CF₂CF═CF₂, —C≡CCF₃, —CF₂C≡CF, —C≡CCF₂CF₃, —CF₂CF₂C≡CF, —C(O)CF₃, —C(O)(CF₂)ₙCF₃ (n=1 to 6), —C(O)C₆F₅, —C(O)C₆F₄CF₃, —C₆F₅, —C₆F₄CF₃, —C₆F₄CF₂CF₃, —C₆F₃(CF₃)CF₃ (all ortho, meta and para isomers), —CF₂C₆F₅, —CF₂CF₂C₆F₅, —CF₂C₆F₄CF₂ (all ortho, meta and para isomers).

In one embodiment, at least one of the groups R₁, R₂ or R₃ is independently selected from —Y, —OY, —SY, —NY₂. In another embodiment, two of the groups R₁, R₂ or R₃ are independently selected from —Y, —OY, —SY, —NY₂.

In one embodiment, one of the groups R₁, R₂ or R₃ is F. In another embodiment, two of the groups R₁, R₂ or R₃ are F.

In a more specific embodiment, it is R₁ that is —Y, —OY, —SY, —NY₂ as described in any embodiment herein. In a more specific embodiment, it is R₁ that is —Y as described in any embodiment herein. In a more specific embodiment, it is R₁ that is —OY and/or —NY₂ as described in any embodiment herein.

In a more specific embodiment, it is R₂ that is —Y, —OY, —SY, —NY₂ as described in any embodiment herein. In a more specific embodiment, it is R₂ that is —Y as described in any embodiment herein. In a more specific embodiment, it is R₂ that is —OY and/or —NY₂ as described in any embodiment herein.

In a more specific embodiment, it is R₃ that is —Y, —OY, —SY, —NY₂ as described in any embodiment herein. In a more specific embodiment, it is R₃ that is —Y as described in any embodiment herein. In a more specific embodiment, it is R₃ that is —OY and/or —NY₂ as described in any embodiment herein.

In a more specific embodiment, it is R₁ and R₃ that are —Y, —OY, —SY, —NY₂ as described in any embodiment herein. In a more specific embodiment, it is R₁ and R₃ that that are —Y as described in any embodiment herein. In a more specific embodiment, it is R₁ and R₃ that that are —OY and/or —NY₂ as described in any embodiment herein.

In an embodiment, in any embodiment described herein, alkyl, alkenyl and alkynyl at Y is alkyl.

In another preferred embodiment, at least one of the groups R₁, R₂ or R₃ is F and Y is a polymeric group comprising repeating units selected from alkylene oxide, alkylene imine, styrene, acrylate, maleimide, phosphazene, siloxane, vinyl alcohol, vinyl amine or mixtures thereof, preferably the polymeric group comprises repeating units selected from alkylene oxide, alkylene imine, acrylate, maleimide, phosphazene, siloxane, vinyl alcohol, vinyl amine or mixtures thereof, more preferably the polymeric group comprises repeating units selected from alkylene oxide, acrylate or maleimide repeating units. These repeating units have the same meaning and particular embodiments as provided for the conductive polymer below. In another preferred embodiment, Y is a polymeric group comprising repeating units of alkylene oxide or alkylene imine, more preferably of alkylene oxide.

In another preferred embodiment, the compound of formula I is selected from any of the following structures:

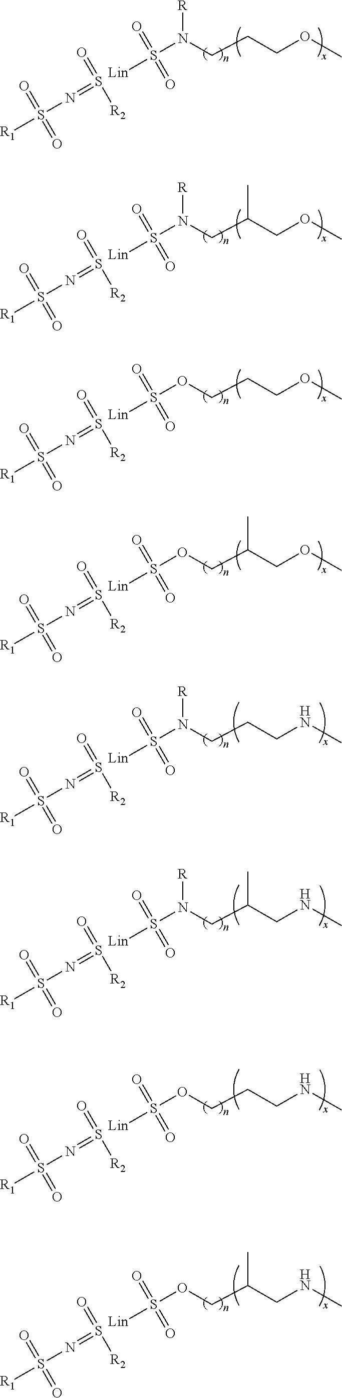

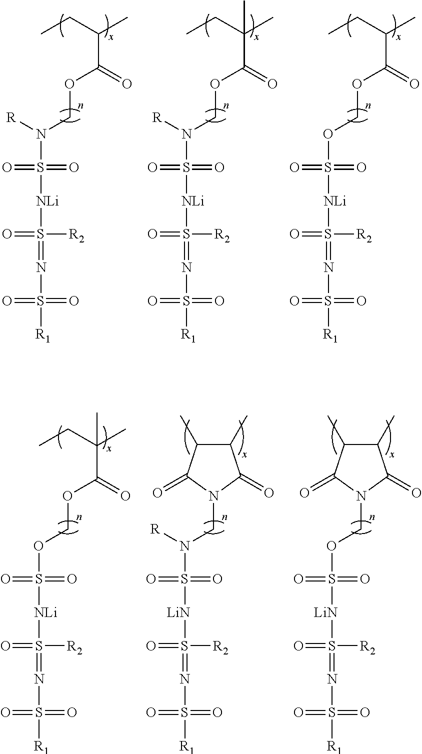

Wherein n is comprised between 1 and 16, x is defined as below, and at least one of R₁ or R₂ is F; more preferably R₁ or R₂ is F and the remainder is a perfluoroalkyl group. More preferably, R₁ or R₂ is F, and R₃ is OY or NY₂, where Y is a polymeric group comprising repeating units of alkylene oxide. More preferably, either R₁ or R₂ is F while the remaining group is a perfluoroalkyl, and R₃ is OY or NY₂, where Y is a polymeric group comprising repeating units of alkylene oxide.

In another embodiment, R₁ or R₂ is F, and R₃ is OY or NY₂, where Y is a polymeric group comprising repeating units of alkylene imine. More preferably, either R₁ or R₂ is F while the remaining group is a perfluoroalkyl, and R₃ is OY or NY₂, where Y is a polymeric group comprising repeating units of alkylene imine.

In another embodiment, R₁ or R₂ is F, and R₃ is OY or NY₂, where Y is a polymeric group comprising repeating units of acrylate. More preferably, either R₁ or R₂ is F while the remaining group is a perfluoroalkyl, and R₃ is OY or NY₂, where Y is a polymeric group comprising repeating units of acrylate.

In another embodiment, R₁ or R₂ is F, and R₃ is OY or NY₂, where Y is a polymeric group comprising repeating units of maleimide. More preferably, either R₁ or R₂ is F while the remaining group is a perfluoroalkyl, and R₃ is OY or NY₂, where Y is a polymeric group comprising repeating units of maleimide.

In a preferred embodiment, the alkylene oxide is ethylene oxide, propylene oxide or a copolymer of these two, wherein the copolymer preferably has the following structure:

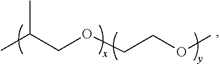

wherein x and y subscripts are positive integers corresponding to a number of repeating units in the polymeric chain and the sum of x and y preferably amounts to at least 100 or at least 1000, and preferably up to 115.000.

In particular, Y is the repeating unit comprised in the polymeric group. The repeating unit comprised in the polymeric group can be bound directly to the rest of the compound of formula I, or it can be bound to the rest of the compound of formula I through a linker, such as shown above. Methods for incorporating salts into polymers are extensively described in Honda, Functionality of Molecular Systems Volume 2 from Molecular Systems to Molecular Devices, Springer-Verlag Tokyo 1999, Chapter 2.1.2; Hatada et al., Macromolecular design of polymeric materials, Marcel Dekker, Inc. 1997, Chapter 22; Aziz et al., Journal of Science: Advanced Materials and Devices, Volume 3, Issue 1, March 2018, Pages 1-17; Zhang et al., Chem. Soc. Rev., 2017, Feb. 6; 46(3):797-815. Examples of repeating units or monomers are shown in parentheses below (the bond outside the parentheses does not define a methyl group but denotes a bond to the rest of the polymer, such as to other repeating units, to terminal groups, to the rest of the compound of formula I, or to the linker):

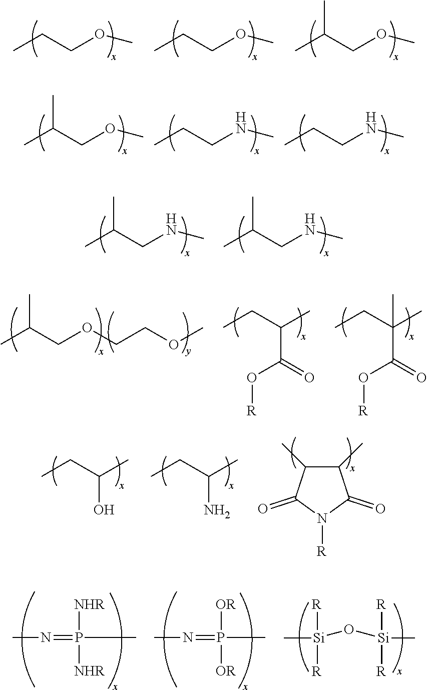

wherein R is alkyl as defined elsewhere throughout the text and x and y subscripts are positive integers corresponding to a number of repeating units in the polymeric chain and is preferably at least 100 or at least 1000, and preferably up to 115.000. The repeating unit of the polymeric group may be connected to the sulfur atoms of the compounds of formula I via carbon atom or via a heteroatom (0, N, P or Si). In an embodiment, the polymeric group is connected via a carbon atom of an alkylene oxide, alkylene imine, acrylate, maleimide, vinyl alcohol, vinyl amine or mixtures thereof. In this sense, they could be considered as a particular case of Y being a substituted aliphatic chain bearing alkylene oxide, alkylene imine, acrylate, maleimide, vinyl alcohol, vinyl amine repeating units. In another embodiment, the polymeric group is connected via a heteroatom (such as O, N, P or Si). These polymeric groups can be obtained from the corresponding sulfonamide originally bearing the repeating unit or from a sulfonamide that can be later modified to introduce the repeating unit. For example, a sulfonamide with the formula NH₂—SO₂(CH₂)ₙ—OY′ or NH₂—SO₂—(CH₂)ₙ—NY′₂ where initially Y′ is a protecting group, can be later substituted by an alternative Y, which is a polymeric group. (CH₂)ₙ in the previous formula indicates that OY′ and NY′₂ can be directly linked to the sulfur (n=0) or there might be a linker between the sulfur and oxygen/nitrogen atoms (n=1, 2, 3, etc.).

More details were already provided above for alkylene oxide and alkylene imine substitution. Another strategy is the reaction of a sulphonamide bearing an S-halogen bond with a precursor of a Y polymeric group.

Terminal group(s) comprised in the polymeric group depend on the type of repeating unit that terminates the polymer chain and the type of reaction employed for polymerization.

In an embodiment, the terminal group(s) are H or alkyl as described above, preferably H or methyl, more preferably H.

In a particular embodiment, the polymer group has a molecular weight of between 50 Dalton and 5000000 Dalton (preferably measured by gel-permeation chromatography).

In an embodiment, the polymeric group that Y represents is the conductive polymer comprised in the SSE, such as in the SPE. In another embodiment, the polymeric group that Y represents is not the conductive polymer comprised in the SSE, such as in the SPE.

In any of these embodiments, the SSE, such as the SPE, comprises a conductive polymer in addition to the compound of formula I.

In an embodiment, when the conductive polymer comprised in the SSE comprises repeating units selected from alkylene oxide, alkylene imine, acrylate, maleimide, phosphazene, siloxane, vinyl alcohol, vinyl amine or mixtures thereof, the polymeric group that Y represents is the conductive polymer comprised in the SSE.

### Solid Electrolyte

A solid electrolyte, preferably solid polymer electrolyte incorporating the ionic compound of formula I displays an improved total ionic conductivity as compared to the solid electrolyte comprising other analogous salts reported in the state-of-the-art as described in the background of the invention.

The solid electrolyte aka solid-state electrolyte (SSE) comprising the ionic compound can be a solid polymer electrolyte (SPE) or a composite polymer electrolyte (CPE).

Preferably, the electrolyte is an SPE. The SPE can be prepared according to standard procedures known in the art to combine the ionic compound with a polymeric conductive electrolyte. For example polymer electrolytes (SPEs) of different thicknesses can be prepared by standard solvent casting methods, wherein the ionic compound and the polymer electrolytes are dissolved in a common solvent or mixture of solvents suitable for their solubilisation; followed by drying and hot-pressing. Methods for preparing SPEs and CPEs are reviewed in Chen et al. (2020) Manufacturing Strategies for Solid Electrolyte in Batteries. Front. Energy Res. 8:571440.

Polymers suitable for SPEs are well-known in the art, such as in Aziz et al., Journal of Science: Advanced Materials and Devices, 2018, (1):1-17. The polymer comprises monomeric units capable of coordinating and decoordinating metal cations, either directly or when forming anion clusters, stemming from the electrodes, allowing for conduction of said metal cations across the different coordinating units by a process of sequential coordination and decoordination under an electric field, effectively transporting said metal cations from the anode to the cathode (when discharging) or from the cathode to the anode (when charging). In such a conduction mechanism, the strength of coordination between the metal cations and the coordinating units, as well as the segmental motion of the conductive polymer chains comprising the coordinating units largely determine the rate of metal cation transport across the electrolyte. Typically, the coordination/decoordination process involves non-covalent interactions, preferably electrostatic interactions such as ionic interactions, and van der Waals forces, such as dipole-dipole interactions between the monomeric units and the metal cation, in particular between atoms of the monomeric units with lone electron pairs, such as on O, N, S or halide atoms, and the metal cation. A conductive polymer is suitable for conducting metal cations.

Therefore, in an embodiment, the conductive polymer comprised in the SPE comprises monomeric units that are capable of coordinating and decoordinating metal cations, preferably alkali metal cations, such as Li or Na cations. These monomeric units are also herein referred to as conductive monomeric units. The monomeric units are comprised in an amount sufficient to provide transport of the metal cations from one electrode to the other under an electric field applied during operation of the electrochemical cell or battery. What is sufficient is something the skilled person can determine based on the specifics of each case, such as the specific nature of the metal cation, the specific electrodes, the specific conductive polymer, or additives employed, or the operating conditions, such as operating voltage, of the electrochemical cell.

The term “monomeric unit”, or “unit” (in the context of polymers), or “repeating unit”, refers to the structural motif in a polymer that stems from a monomer that has been subjected to polymerisation. It is distinguished from the monomer in that it is part of the polymer, whereas a monomer is an independent molecular entity which can be polymerised into a polymer. It is commonplace in the art to refer to monomeric units according to the structure of the monomer, even though the monomeric unit itself may no longer show exactly the same structure as the monomer. Thus, for instance, “styrene monomeric unit” actually refers to a monomeric unit derived from a styrene monomer by polymerisation, even though the styrene monomeric unit no longer comprises the alkene group of styrene. The same applies to acrylate monomeric units. Similarly, ethylene oxide monomeric units do not actually comprise ethylene oxide epoxide, but refer to the unit resulting from its polymerization. The skilled person is well aware of which monomers correspond to which monomeric units. Similarly, the skilled person is well aware of how to convert monomers into corresponding monomeric units by a process of polymerization. It is understood that the monomers must be polymerizable, i.e. they must comprise a functional group which can react with other monomers in a polymerization reaction. Polymerization reactions are similarly well known by the person skilled in the art and include thermal polymerization, photopolymerisation, or solution polymerizations employing a radical initiator such as azobisisobutyronitrile, benzoyl peroxide, di-tert-butyl peroxide, lauryl peroxide, cumene hydroperoxide, t-butyl peroxypivalate, diisopropyl peroxydicarbonate, or ammonium persulfate. The term “polymer”, also identified by the prefix “poly”, herein refers to a molecule comprising at least 10 monomeric units, such as at least 100 or at least 1000 monomeric units; or such as up to 115.000 monomeric units. The polymer can be obtained by polymerising monomers in a linear, branched or crosslinked manner. Polymers may adopt particular structures such as comb-like, brush-like, star-like or flower-like structures, or even more complex structures. Unless otherwise indicated, poly[monomeric unit X], herein refers to a molecule comprising at least 10 X monomeric units, such as at least 100 or at least 1000 X monomeric units or such as up to 115.000 X monomeric units, wherein monomeric unit X refers to a specific monomeric unit.

In any embodiment described herein referring to a polymer comprising different monomeric units (co-polymers), the different monomers may be comprised in the polymer in an alternating, random, block or graft fashion. In particular, the polymer may be an alternating, random, block or graft copolymer of different monomeric units.

In an embodiment, the conductive polymer comprised in the SPE comprises monomeric units selected from alkylene oxide such as ethylene oxide or propylene oxide; alkylene imine such as ethyleneimine; alkylene sulphide such as ethylene sulphide; alkylene carbonate, such as trimethylenecarbonate, ethylenecarbonate or propylenecarbonate; acrylate, in particular alkylacrylates and alkyl esters thereof, such as methylmethacrylate; phosphazene, such as bis(2-(2-methoxyethoxy)ethoxy) phosphazene; siloxane, such as dimethyl siloxane; vinyl alcohol or vinyl amine; vinyl acetate; vinyl halides, such as vinyl chloride or vinylidene difluoride; hexafluoropropylene; acrylonitrile; vinylpyrrolidone; ε-caprolactone; maleimide, such as alkylene maleimide, e.g. ethylene-alt-maleimide; or aniline units.

The terms “alkyl” and “alkylene” have the meaning described further above.

The presence or amounts of monomeric units can be identified or calculated by different methods known to the skilled person. In an embodiment, they are determined by NMR spectroscopy, such as ¹H-NMR spectroscopy, more particularly by ¹H-NMR at 500 MHz, preferably at room temperature. The polymer sample is dissolved in a deuterated solvent, such as CDCl₃, D₂O, or (CD₃)₂SO, and analysed by said spectroscopic technique. Suitable equipment for carrying out the reading is for example a WB 500 MHz Bruker Advance III. In the obtained spectrum, peaks characteristic to the monomeric units of interest are integrated and their ratio is established.

Optionally, copolymers of known different monomeric unit contents can be prepared in advance, a calibration can be produced, and this used to interpret the spectra obtained for samples of unknown monomeric unit content.

In a preferred embodiment, the conductive polymer comprised in the SPE comprises alkylene oxide monomeric units such as ethylene oxide or propylene oxide units. Preferably the alkylene oxide is ethylene oxide. The ethylene oxide (typically abbreviated as EO) monomeric unit has the formula —(CH₂CH₂O)—:

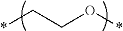

wherein the monomeric unit is shown in parentheses and * denotes a bond to the rest of the polymer. In an embodiment, the molar ratio of alkylene oxide units to metal cation, such as Li cation, in the SSE ranges from 4:1 to 64:1, preferably from 8:1 to 30:1, and more preferably from 12:1 to 25:1, and particularly it is 20:1.

In an embodiment, all the monomeric units in the conductive polymer comprised in the SPE which are capable of coordinating and decoordinating a metal cation are selected from the above listed monomeric units. In an embodiment, all the monomeric units in the conductive polymer are selected from the above listed monomeric units. In an embodiment, the conductive polymer comprises only one of the above listed monomeric units or it is a homopolymer of one of the above listed monomeric units. In any of these embodiments or any embodiment described herein, the monomeric unit is an alkylene oxide, and even more preferably it is an ethylene oxide monomeric unit.

In an embodiment, the conductive polymer comprised in the SPE is selected from a polyalkylene oxide such as polyethylene oxide (PEO) or polypropylene oxide (PPO); a polyalkylenimine such as polyethyleneimine (PEI); a polyalkylene sulphide such as polyethylene sulphide (PES); a polyalkylene carbonate, such as polytrimethylenecarbonate (PTMC), polyethylenecarbonate (PEC) or polypropylenecarbonate (PPC); a polyacrylate, in particular a polyalkylacrylate or an alkyl ester thereof, such as polymethylmethacrylate (PMMA); a polyphosphazene, such as poly[bis(2-(2-methoxyethoxy) ethoxy) phosphazene (MEEP); a polysiloxane, such as poly(dimethyl siloxane) (PDMS); polyvinyl alcohol (PVA) or polyvinyl amine (PVAm); polyvinyl acetate (PVAc); polyvinyl halide, such as polyvinyl chloride (PVC) or polyvinylidene difluoride (PVdF); polyvinylidene difluoride-hexafluropropylene (PVdF-HFP); polyacrylonitrile (PAN); poly(vinylpyrrolidone) (PVP); poly(2-vinylpyridine) (P2VP); poly(ε-caprolactone) (PCL); poly(maleimide), such as poly(alkylene maleimide), e.g. poly(ethylene-alt-maleimide) (PEaMI); polyaniline (PANI); chitosan (CS); or any copolymer thereof.

A preferred polymer is a PEO according to the following formula:

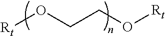

wherein n denotes the number of EO monomeric units, which may be anywhere between 10 and 220 000; and Rt is H or alkyl, such as H or methyl, preferably it is H.

In an embodiment, the poly(alkylene oxide), such as poly(ethylene oxide), has a weight-average molecular weight of from 300 g/mol to 10 000 000 g/mol, preferably of from 20 000 g/mol to 10 000 000 g/mol, more preferably of from 3 000 000 g/mol to 7 000 000 g/mol, and in a particular embodiment it is of about 5 000 000 g/mol, as determined by gel permeation chromatography, such as according to ISO/DIS 13885-3(en). Such polymers are commercially available, such as from Sumitomo Seika Chemicals co., ltd. (Products PEO-1 to PEO-29) or from Sigma-Aldrich (189472; CAS 25322-68-3).

In another embodiment, a blend of conductive polymers as described above is comprised in the SPE. The term blend as used herein refers to a mixture of two or more components, in particular two or more polymers. Blends are obtainable by common methods known to the skilled person, such as mechanical blending, solution blending, or melt blending. In an embodiment, the polymer blend is obtained by solution blending, more particularly by dispersing or dissolving the polymers in a solvent, mixing, and evaporating the solvent.

Polymer blends may be miscible, when the blend exhibits a single glass transition temperature (Tg); or immiscible, when the blend exhibits the Tg of its constituent polymers.

In an embodiment, the amount of the conductive polymer or blend thereof comprised in the SPE is from 0 to 90 weight % with respect to the total weight of the SPE. In another embodiment, the weight ratio between the conductive polymer or blend thereof comprised in the SPE and the ionic compound of formula I comprised in the SPE is from 0:100 to 90:10. The conductive polymer is herein interpreted to be at an amount of 0% or ratio of 0:100 when it is the Y group in the compound of formula I of the present invention.

Thus, the SPE of the invention comprises a conductive polymer, more specifically a metal-cation-conductive polymer, even more specifically a lithium-cation-conductive polymer; and the compound of formula (I). In an embodiment, the compound of formula (I) and the polymer form a single species, e.g. they are covalently bound to each other.

Such conductive polymers comprising monomeric units covalently bound to the salt are known in the art as single-ion conductors and represent a preferred embodiment of the present invention. Single-ion conductors are well known in the art such as from Honda, Functionality of Molecular Systems Volume 2 from Molecular Systems to Molecular Devices, Springer-Verlag Tokyo 1999, Chapter 2.1.2; Hatada et al., Macromolecular design of polymeric materials, Marcel Dekker, Inc. 1997, Chapter 22; Aziz et al., Journal of Science: Advanced Materials and Devices, Volume 3, Issue 1, March 2018, Pages 1-17; Zhang et al., Chem. Soc. Rev., 2017, Feb. 6; 46(3):797-815. The salt may be directly bound, or bound through a linker, to the monomeric unit comprised in the conductive polymer, such as in the backbone thereof. When the conductive polymer is a copolymer, the salt may be covalently bound to one or more of the monomeric unit types comprised in the conductive polymer. Particularly preferred monomeric units to which the salt can be covalently bound are selected from alkylene oxide, alkylene imine, acrylate, maleimide, phosphazene, siloxane, vinyl alcohol, vinyl amine units and mixtures thereof. The conductive polymer may alternatively be a copolymer comprising conductive monomeric units (i.e. units capable of coordinating and decoordinating metal cations) and non-conductive monomeric units, wherein the salt is covalently bound to at least the non-conductive monomeric units. In such a case, non-conductive monomeric units are comprised in the conductive polymer in an amount that does not compromise the transport of the metal cations between electrodes during charge or discharge of the electrochemical cell. In an embodiment, the amount of non-conductive monomeric units (including covalently bound salt) comprised in the conductive polymer is of at most 50%, in particular at most 10% by weight with respect to the total weight of the conductive polymer.

In another embodiment, the weight ratio between the conductive polymer or blend thereof comprised in the SPE and the ionic compound of formula I comprised in the SPE is from from 1:99 to 90:10, more preferably 10:90 to 80:20, more preferably from 20:80 to 50:50.

In this embodiment, the conductive polymer or blend thereof and the ionic compound of formula I are independent species, e.g. they are not covalently bound to each other.

In an embodiment, the amount of the ionic compound of formula I comprised in the SSE is from 10 to 100, preferably from 10 to 80, more preferably from 20 to 50, % weight with respect to the total weight of the SSE.

The conductive polymer comprised in the SPE can comprise auxiliary monomeric units which are not capable of coordinating the metal cations. The incorporation of such auxiliary monomeric units can serve to fine tune the physiochemical properties of the metal-cation-conductive polymer, such as to improve the mobility of its polymer chains, which can enhance metal cation hopping from one coordination site to the next; or the mechanical strength, which can for instance minimize puncture of the conductive polymer by any dendrites forming at its interface with the anode. In an embodiment, the auxiliary monomeric units are selected from alkylene, such as ethylene or propylene; silane; isoprene or styrene units.

In an embodiment, when the conductive polymer comprises auxiliary monomeric units, these are present in an amount that does not compromise the transport of the metal cations between electrodes. In an embodiment, the amount of the auxiliary monomeric units comprised in the metal-cation-conductive polymer is of at most 50%, in particular at most 10% by weight with respect to the total weight of the SSE.

In an embodiment, the SPE comprises, in addition to the ionic compound and the conductive polymer or blend thereof, an auxiliary polymer or a plasticizer. The incorporation of such additional components can also serve to fine tune the physiochemical properties of the SPE.

In an embodiment, the SPE comprises, in addition to the ionic compound and the conductive polymer or blend thereof, an auxiliary polymer.

The auxiliary polymer can be a polymer comprising more than 60% by weight of the above described auxiliary monomeric units. Providing the modifying properties of said auxiliary monomeric units through a separate polymer as opposed to integrating them within the conductive polymer can be a useful option when said integration is not simple from a synthetic point of view.

In a preferred embodiment, the auxiliary polymer is a homopolymer of one of said auxiliary monomeric units described above, such as a polyalkylene, e.g. polyethylene or polypropylene; a polysilane; polyisoprene or polystyrene. In another embodiment, the auxiliary polymer is a copolymer of two or more of said auxiliary monomeric units described above.

In an embodiment, the amount of auxiliary polymer in the SPE is from 0.1 to 30 by weight % with respect to the total weight of the SPE.

In an embodiment, the SPE comprises a plasticizer. Plasticizers can enhance the conductivity of the SPE by decreasing the glass temperature (T_{g}) of the SPE, ultimately lowering the operational temperature of the electrochemical cell.

In an embodiment, the plasticizer is selected from ethylene glycols or alkyl ethers thereof.

The ethylene glycol is preferably an alkyl-terminated polyethylene glycol (e.g. PEGDME-200, PEGDME-400, PEGDME-600), tetraethylene glycol dimethyl ether, triethylene glycol dimethyl ether, or diglyme, more preferably it is polyethylene glycol dimethyl ether. The polyethylene glycol preferably has a weight-average molecular weight of from 300 to 19 000 g/mol as determined by gel permeation chromatography, such as according to ISO/DIS 13885-3(en).

In an embodiment, the plasticizer is an aprotic organic solvent. The aprotic organic solvent is preferably an aprotic ether, ester, carbonate, nitrile, sulfonamide or amide.

Specific examples thereof include propylene carbonate, gamma-butyrolactone, butylene carbonate, ethylene carbonate, dimethyl carbonate, ethylmethyl carbonate, diethyl carbonate, 1,2-dimethoxyethane, 1,2-dimethoxypropane, 3-methyl-2-oxazolidone, tetrahydrofuran, 2-methyltetrahydrofuran, 1,3-dioxolane, 4-methyl-1,3-dioxolane, tert-butyl ether, isobutyl ether, 1,2-ethoxymethoxy ethane, dimethyl ether, methyl formate, methyl acetate, methyl propionate and 2-keto-4-(2,5,8,11-tetraoxadodecyl)-1,3-dioxolane (MC3), dialkyl phthalates such as dimethyl phthalate (DMP), diethyl phthalate (DEP), dibutyl phthalate (DBP) or di(ethyl-hexyl) phthalate (DEP), dimethylformamide (DMF). Two or more of the aprotic organic solvents may be used in combination.

In an embodiment, the plasticizer is an ionic liquid. Examples of suitable ionic liquids are 1-butyl-3-methylimidazolium-bis(trifluoromethanesulfonyl)imide (BMITFSI); 1-ethyl-3-methylimidazolium-bis(trifluoromethanesulfonyl)imide (EMITFSI); N-methyl-N-propylpiperidinium-bis(trifluoromethanesulfonyl)imide (PP₁₃TFSI); 1-ethyl-3-methyl imidazolium trifluoromethanesulfonate (EMITf); N-butyl-N-ethylpyrrolidinium-bis(trifluoromethanesulfonyl)imide (Pyr₂₄TFSI); 1-n-propyl-2,3-dimethylimidazolium tetrafluoroborate (MMPIBF4); or 1-n-propyl-2,3-dimethylimidazolium hexafluorophosphate (MMPIPF₆).

In a preferred embodiment, the plasticizer is liquid at room temperature (22° C.).

In an embodiment, the amount of the plasticizer in the SPE is from 0.1 to 80 weight % with respect to the total weight of the SPE.

In another embodiment, the SPE comprises no plasticizer or comprises only traces thereof, such as 0.1% by weight or less with respect to the total weight of the SPE. In another embodiment, it further comprises no organic liquid or comprises only traces thereof, such as 0.1% by weight or less with respect to the total weight of the SPE.

In an embodiment, the SSE is a CPE comprising the conductive polymer or blend thereof as described above, and an inorganic material such as a ceramic material.

Examples of suitable inorganic materials are metal oxides such as SiO₂, Al₂O₃, TiO₂, LiAlO₂, ZrO₂ or Mg₂B₂O₅; zeolites, such as NaₙAlₙSi₉₆₋ₙO₁₉₂·16H₂O (0<n<27); garnets, including Li₅-phase lithium garnets, e.g., Li₅La₃M¹₂O₁₂, where M¹ is Nb, Zr, Ta, Sb, or a combination thereof; Li₆-phase lithium garnets, e.g. Li₆DLa₂M³₂O₁₂, where D is Mg, Ca, Sr, Ba, or a combination thereof and M³ is Nb, Ta, or a combination thereof; and Li₇-phase lithium garnets, e.g. Li₇La₃Zr₂O₁₂ and Li₇Y₃Zr₂O₁₂; perovskites, typically of formula Li₃ₓLa_{2/3-x} TiO₃, such as Li_{3.3}La_{0.56}TiO₃; argyrodites, such as Li₆PS₅Cl; sulfides, such as Li₂S—P₂S₅; metal hydrides, such as Li₂B₁₂H₁₂, Li₂B₁₀H₁₀; metal halides, such as LiI; NASICON-structured materials, typically with the structure Na₁₊ₓZr₂SiₓP₃₋ₓO₁₂ or equivalents where Na, Zr and/or Si are replaced by isovalent elements, such as Na₃Zr₂(SiO₄)₂(PO₄); LISICON-structured materials, typically with the structure Li₂₊₂ₓZn₁₋ₓGeO₄, or equivalents where Zn and/or Ge are replaced by isovalent elements, such as Li₁₄Zn(GeO₄)₄; borates, such as Li₂B₄O₇; or metal phosphates, such as Li₃PO₄. In an embodiment, the amount of inorganic material comprised in the CPE is from 1 to 90 weight % with respect to the total weight of the CPE. In an embodiment, the amount of the conductive polymer or blend thereof comprised in the CPE is from 10 to 99 weight % with respect to the total weight of the CPE. In an embodiment, the ratio of inorganic material to conductive polymer or blend thereof in the CPE is from 1:89 to 10:80. The CPE may further comprise any of the additional components described for the SPE.

In an embodiment, the SSE is compatible with the anode of choice. Being compatible herein means that the SSE is not degraded when brought into direct contact with the anode, preferably when operating (charging/discharging) the electrochemical cell. The skilled person knows how to select SSEs based on the anode chosen for the electrochemical cell.

### Uses and Applications

The solid electrolyte, preferably solid polymer electrolyte comprising the ionic compounds of formula I can be comprised in a secondary electrochemical cell or a secondary battery, which further comprise an anode and a cathode.

The terms “secondary electrochemical cell” and “secondary battery” refer to an electrochemical cell and battery, respectively, in which charging and discharging operations are reversible. The charging and the discharging of the electrochemical cell and battery is accomplished by the reversible incorporation of metal cations at the negative electrode (anode) and positive electrode (cathode). During discharge, electrons are liberated at the anode by an oxidation process, resulting in an electron current, usually via an external load, to the cathode where the electrons are taken up by a reduction process. At the same time, charge carriers are released from the anode in the form of metal cations, which can migrate to the cathode where they are incorporated. Charge carrier migration is ensured by the conductive electrolyte. Conversely, during charge, the opposite reaction takes place, whereby the electrons and metal cations are released from the cathode and are incorporated at the anode.

In an embodiment, the secondary electrochemical cell or secondary battery comprises a) an anode, b) a cathode and c) the solid electrolyte of the invention.

In an embodiment, the anode is suitable for reversibly incorporating metal cations, preferably alkali metal cations, and more preferably lithium cations. More specifically, the anode comprises an active material, which is the component of the anode enabling said reversible incorporation to take place.

The incorporation of the metal cations in the anode can occur by different mechanisms depending on the specific anode active material the anode comprises. Typical mechanisms are plating of the metal cation onto the anode, wherein the anode itself may comprise the same metal cation, such as the plating of lithium cations onto a metallic lithium anode, or wherein the anode may not comprise the same metal cation, such as the plating of lithium cations onto a copper foil; intercalation or insertion of the metal cation into the structure of the anode, such as the intercalation of lithium ions into carbonaceous materials, e.g. graphite; or reaction of the metal cation with species present in the anode, such as metals (alloying), or transition metal oxides or nitrides (conversion). The reverse processes are, respectively, stripping, deintercalation and deconversion.

In another embodiment, the anode comprises the metal cations, preferably alkali metal cations, and more preferably lithium cations. In a particular embodiment, the anode is an anode obtainable from the incorporation of the metal cations by any of the above-mentioned incorporation mechanisms.

In an embodiment, the anode is selected from a metal anode, preferably an alkali metal anode, and more preferably a lithium metal anode.

In another embodiment the anode comprises a carbonaceous material suitable for reversibly incorporating, such as reversibly intercalating, metal cations, preferably alkali metal cations, and more preferably lithium cations. Examples of suitable carbonaceous materials are graphite, acetylene black, carbon black, coke, glassy carbon or mixtures thereof. The skilled person knows how to select appropriate carbonaceous materials based on the specific metal cation to be incorporated in the anode. In an embodiment, the anode comprises said carbonaceous materials with the metal cations incorporated in them.

In another embodiment the anode comprises a metal oxide or metalloid oxide suitable for reversibly incorporating, such as reversibly intercalating, metal cations, preferably alkali metal cations, and more preferably lithium cations. In another particular embodiment the metal cation is a sodium cation. The metal oxide or metalloid oxide is preferably a metal oxide, even more preferably it is a titanium, vanadium or niobium oxide, and most preferably it is a titanium oxide. Examples of suitable metal oxides are TiO₂ (such as rutile, anatase or B forms), Li₄Ti₅O₁₂, Li₂Ti₃O₇, Li₂Ti₆O₁₃, H₂Ti₃O₇, Nb₂O₅, V₂O₅, TiNb₂O₇. The skilled person knows how to select appropriate metal oxides or metalloid oxides based on the specific metal cation to be incorporated in the anode. In an embodiment, the anode comprises metal or metalloid oxides with the metal cations incorporated in them.

In another embodiment the anode comprises a metal or metalloid suitable for reversibly forming an alloy with metal cations, preferably alkali metal cations, and more preferably lithium cations. The skilled person knows how to select appropriate metals or metalloids suitable for forming the alloy. For instance, examples of metals or metalloids suitable for reversibly forming an alloy with lithium cations are Mg, Al, Zn, Bi, Cd, Sb, Ag, Si, Pb, Sn, or In which in particular can form alloys such as LiMg, LiAl, LiZn, Li₃Bi, Li₃Cd, Li₃Sb, Li₄Ag, Li_{4.4}Si, Li_{4.4}Pb or Li_{4.4}Sn. In an embodiment, the anode comprises such alloys.

In another embodiment the anode comprises a transition metal- or metalloid-oxide, -sulfide, -selenide, -fluoride, -nitride or -phosphide, suitable for reversibly incorporating, such as by reversible conversion, metal cations, preferably alkali metal cations, and more preferably lithium cations. The conversion reaction typically comprises displacement of the transition metal or metalloid by the metal cation to yield the corresponding metal-oxides, -sulfides, -selenides, -fluorides, -nitrides or -phosphides. This reaction is usually expressed according to equation (1):

MₐX_{b}+(b×c)C⁺+(b×c)e⁻↔aM+bC_{c}X (1)

wherein M is the transition metal or metalloid; X is the -oxide, -sulfide, -selenide, -fluoride, -nitride or -phosphide anion; C⁺ is the metal cation; and e⁻ is an electron.

The transition metal or metalloid is preferably a transition metal, more preferably a transition metal selected from Mn, Fe, Co, Cr, Ni, Cu, Ru, Mo, W. The oxide is preferred amongst the -oxide, -sulfide, -selenide, -fluoride, -nitride and -phosphide. Examples of suitable transition metal- or metalloid-oxides, -sulfides, -selenides, -fluorides, -nitrides or -phosphides are Fe₂O₃, Fe₃O₄, CoO, Co₃O₄, MoS₂, MnSe, MnF₂, WN, NiP₂. The skilled person knows how to select appropriate transition metal or metalloid-oxides, -sulfides, -selenides, -fluorides, -nitrides or -phosphides based on the specific metal cation to be incorporated in the anode. In an embodiment, the anode comprises said transition metal- or metalloid-oxides, -sulfides, -selenides, -fluorides, -nitrides or -phosphides with the metal cations incorporated in them, i.e. the corresponding metal-oxides, -sulfides, -selenides, -fluorides, -nitrides or -phosphides.

In an embodiment, the anode comprises a mixture of the above-mentioned materials suitable for reversibly incorporating metal cations.

Anodes as described herein are commercially available and well known in the art, such as from Fang et al., Adv. Energy Mater, 2020, 10, 1902485.

The cathode of the electrochemical cell of the present invention is suitable for reversibly incorporating metal cations, preferably alkali metal cations, and more preferably lithium cations. More specifically, the cathode comprises an active material, which is the component of the cathode enabling said reversible incorporation to take place.

Although the incorporation of the metal cations in the cathode can occur by different mechanisms, the grand majority of known cathodes, especially those on the market employ intercalation/deintercalation.

In another embodiment, the cathode comprises the metal cations, preferably alkali metal cations, and more preferably lithium cations. In a particular embodiment, the cathode is a cathode obtainable from the intercalation of the metal cations in its structure, in particular at its active site.

In an embodiment, the cathode comprises an active material selected from one of the following:
a lithium nickel-rich layered oxide of formula Li_{y}Ni₁₋ₓMₓO₂, wherein M represents at least one metal and 0≤x≤1, 0.8≤y≤1.2;
a spinel oxide of formula LiNi₂₋ₓMₓO₄, wherein M represents at least one transition metal and 0≤x≤2;
a lithium-rich layered oxide of formula Li₁₊ₓM₁₋ₓO₂ wherein M represents at least one transition metal and 0≤x≤1;
a lithium polyanion of formula Li₂MSiO₄ wherein M is Mn, Co or Ni; of formula LiMPO₄ wherein M is Fe, Co or Ni; of formula Li₂MP₂O₇ wherein M is Mn, Co or Ni; or of formula Li₃V₂(PO₄)₃, Li₂VOP₂O₇, or LiVP₂O₇; and
a phosphate or sulfate of formula Li_{y}MXO₄Z; wherein y=0, 1, 2; M=transition metal; X=P, S; Z=F, O, OH.

Cathodes as described herein are commercially available and well known in the art, such as from Li et al., Chem Soc Rev, 2017, 46, 3006-3059, or Lyu et al., Sustainable Materials and Technologies, 2019, 21, e00098.

The cathodes of the present invention may further comprise a conductive carbon material such as carbon black or activated carbon. Preferably, the conductive carbon material is carbon black. The term “carbon black” [C.A.S. NO. 1333-86-4] refers to colloidal aciniform carbon particles produced by the incomplete combustion or thermal decomposition of gaseous or liquid hydrocarbons such as heavy petroleum distillates and residual oils, coal-tar products, natural gas or acetylene. Its physical appearance is that of a black, finely divided pellet or powder.

In an embodiment, in any of the embodiments disclosed herein, the electrochemical cell presents a layered configuration. More particularly, the electrochemical cell comprises:
an anode layer, which presents a surface that contacts a SSE layer;
a cathode layer, which presents a surface that contacts the SSE layer;
the SSE layer, which presents a first surface that contacts the anode layer, and a second surface that contacts the cathode layer.

As used herein, the term “layer”, “film” or “sheet” refers to a three dimensional structure having two dimensions that are substantially greater, such as at least two-fold greater, or ten-fold greater, than the third dimension.

Methods for forming layers or depositing layers on surfaces are well known to the person skilled in the art and include spray coating, spin coating, screen printing, dip coating or inkjet printing.

The electrochemical cell and battery of the invention further comprise a cathode-side current collector, such as Al foil, and an anode-side current collector, such as Cu. A separator is not necessary as the SSE itself physically separates the anode and cathode.

It is to be understood that when any part of the SSE, electrochemical cell or battery comprises different materials, the specific amount of each of said materials is selected from the herein described ranges so as to total 100% wt of the part.

In a particular embodiment, the secondary electrochemical cell or secondary battery is a Li-ion or Li metal electrochemical cell or battery.

The present invention is also directed to a vehicle, an electronic device or an electrical grid comprising a secondary electrochemical cell or battery as defined above.

Similarly, the invention is directed to the use of a secondary electrochemical cell or battery as defined above, for storing energy, and more particularly for storing energy in a vehicle, an electronic device or an electrical grid.

The vehicle can be an automobile, in particular a heavy automobile such as buses or trucks, a rail vehicle, a marine vehicle, an aircraft or a spacecraft.

Preferably, the electronic device is a portable electronic device, such as a laptop, a tablet, a cellular phone, a smart phone or a smart watch.

Preferably, the electrical grid is associated to a solar panel or a wind turbine.

### Further Embodiments

### Further Embodiments of the Invention

1. A solid electrolyte comprising a compound of formula I

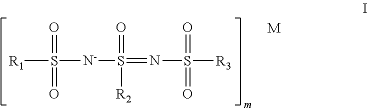

wherein
M is:
   a proton;
   a metal cation having a valency equal to 1, 2 or 3, chosen from ions of alkali metals, of alkaline earth metals, of transition metals or of rare-earth metals;
   an organic onium or polyonium cation;
   an organometallic cation;
m is an integer positive number; and
at least one of the groups R₁, R₂ or R₃ is F and the remainder is independently selected from —Y, —OY, —SY, —NY₂,
   wherein Y represents:
      H or an organic radical chosen from alkyl, alkenyl, alkynyl, acyl, aryl, alkylaryl, arylalkyl, alkylene oxide or alkylene imine, optionally substituted with at least a substituent selected from the group consisting of F, Cl, Br, I, —CN, —OR′, —SR′, —NR′₂, wherein R′ is H, alkyl, alkylene oxide or alkylene imine; or
      a polymeric group comprising repeating units selected from alkylene oxide, alkylene imine, styrene, acrylate, maleimide, phosphazene, siloxane, vinyl alcohol, vinyl amine or mixtures thereof.
2. The solid electrolyte according to embodiment 1, wherein M is Li⁺.
3. The solid electrolyte according to embodiment 1, wherein M is an onium cation selected from the group consisting of ammonium, guanidinium, amidinium, pyridinium, imidazolium, imidazolinium, triazolium, phosphonium, sulfonium and iodonium ions, or a polyonium cation selected from the group consisting of polyammonium, polyphosphonium, polypyridinium, polypyrrolidonium, polyimidazolium, polyimidazolinium and polysulfonium cations.
4. The solid electrolyte according to any one of the preceding embodiments, wherein at least one of the groups R₁, R₂ or R₃ is F and the remainder is independently selected from —Y.
5. The solid electrolyte according to any of the preceding embodiment, wherein Y represents an organic radical chosen from fluorinated or perfluorinated alkyl.
6. The solid electrolyte according to any one of the preceding embodiment, wherein at least one of the groups R₁, R₂ or R₃ is F and the remainder is independently selected from —OY and/or —NY₂.
7. The solid electrolyte according to any one of the preceding embodiments, wherein Y is alkyl, alkenyl, alkynyl or alkylene oxide.
8. The solid electrolyte according to any one of embodiments 1 to 3, wherein at least one of the groups R₁, R₂ or R₃ is F and Y is a polymeric group comprising repeating units selected from alkylene oxide, alkylene imine, acrylate, maleimide, phosphazene, siloxane, vinyl alcohol, vinyl amine or mixtures thereof.
9. The solid electrolyte according to any one of the preceding embodiments, wherein at least one of the groups R₁, R₂ or R₃ is F and Y is a polymeric group comprising repeating units selected from alkylene oxide, acrylate or maleimide repeating units or mixtures thereof.
10. The solid electrolyte according to any of the preceding embodiments, wherein R₂ is F.
11. The solid electrolyte according to any one of the preceding embodiments, which is a solid polymer electrolyte comprising a conductive polymer.
12. The solid electrolyte according to embodiment 11, wherein the conductive polymer is poly(ethylene oxide).
13. The solid electrolyte according to any one of embodiment 11 or 12, wherein when Y represents a polymeric group, said polymeric group is the conductive polymer comprised in the solid polymer electrolyte.
14. Secondary electrochemical cell or secondary battery comprising the solid electrolyte as defined in any one of embodiments 1 to 13.
15. Vehicle, electronic device or electrical grid comprising at least one electrochemical cell or battery as defined in embodiment 14.

### EXAMPLES

### Example 1: Preparation of Lithium Salts

The structures of salt 1 (LisFTFSI) and previously reported salt 2 (LisTFSI) and salt 3 (LiTFSI) are shown below:

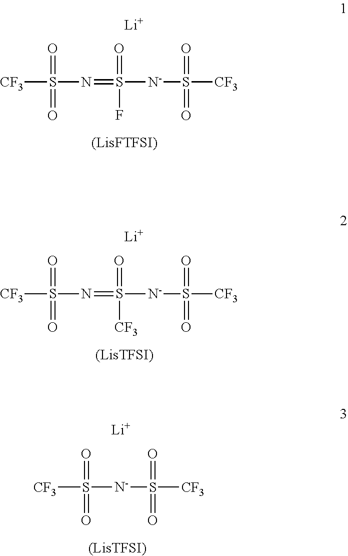

The synthesis of LisTFSI was carried out according to known procedures (H. Zhang et al, J. Power Sources 2015, 296, 142-149).

Battery grade LiTFSI salt was purchased (Solvay, China) and used as received. All reagents for the synthesis of (S-fluoro-N-((trifluoromethyl)sulfonyl)sulfonimidoyl)((trifluoromethyl)sulfonyl)amide (LisFTFSI) were purchased from Sigma-Aldrich and used as received. Solvents were distilled and dried prior to use. Specifically, LisFTFSI was prepared in a one-pot fashion by reaction of a sulphonamide salt with an N-(sulfinyl)sulfonamide and subsequent oxidation with an electrophilic fluorine source. More specifically, the synthetic route to lithium (S-fluoro-N-((trifluoromethyl)sulfonyl)sulfonimidoyl)((trifluoromethyl)sulfonyl)amide (LisFTFSI) is illustrated in the scheme below.

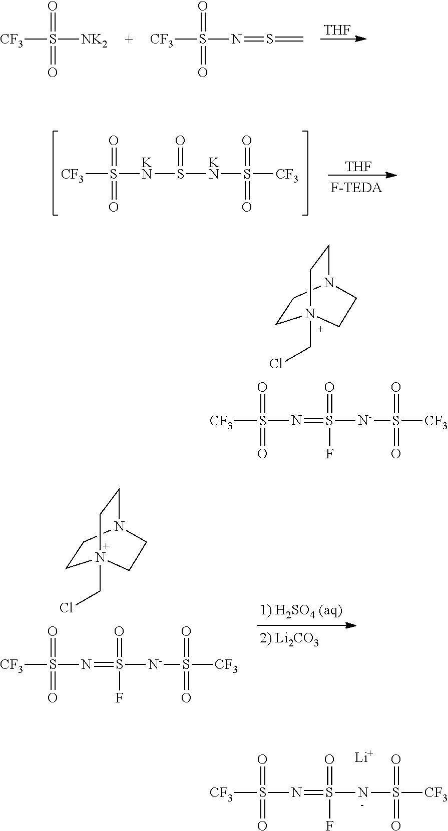

Trifluoromethanesulfonylamide dipotassium salt was obtained by reacting potassium tert-butoxide, KOtBu (7.6 g, 2.5 eq., 68.1 mmol) with trifluoromethanesulfonamide (4.8 g, 32.4 mmol) in THF (70 mL) under reflux for 16 h. The obtained white solid was filtered and washed with abundant THF to yield pure dipotassium salt (6.6 g, 29.2 mmol).

A solution of N-(sulfinyl)trifluoromethanesulfonamide, obtained as described in Journal of Fluorine Chemistry, 60 (1993) 283-288, (6.0 g, 29.2 mmol) in THF (35 mL) was added to a suspension of trifluoromethanesulfonylamide dipotassium salt (6.6 g, 1 eq, 29.2 mmol) in THF (35 mL) at −20° C. The mixture was stirred and allowed to reach room temperature until complete conversion was achieved. A mixture of THF:HFIP (hexafluoro-2-propanol) 6.5:1 (230 mL) was added followed by 1-chloromethyl-4-fluoro-1,4-diazoniabicyclo[2.2.2]octane bis(tetrafluoroborate) (12.0 g, 32.0 mmol). The reaction mixture was stirred until no further evolution. Then, the solvent was removed under reduced pressure to yield an oil containing an alkyl ammonium salt. This oil was taken into water (30 mL) and acidified with H₂SO₄. The aqueous solution was extracted with diethyl ether (3×50 mL), organic fractions were combined, and solvent was removed under reduced pressure. An aqueous solution of the obtained acid, N,N′-bis((trifluoromethyl)sulfonyl)sulfuramidimidoyl fluoride, was treated with lithium carbonate (0.53 g, 0.5 eq., 7.2 mmol) and the reaction mixture stirred for 16 h at room temperature. Then solvent was removed in vacuo to yield a white solid. Excess of lithium carbonate was removed by selective dissolution of impurities and recrystallization from acetonitrile. Solvent was removed in vacuo to yield LisFTFSI as a white powder. ¹⁹F-NMR (283 MHz, MeCN-d3) δ (ppm) 69.18-69.04 (m, 1F, F), −79.36 (d, J=3.2 Hz, 6F, 2× CF₃). ¹³C-NMR (75 MHz, MeCN-d3): δ (ppm) 121.7 (qd, J=320.1 Hz, 2.4 Hz, 2× CF₃).

### Example 2: Preparation of

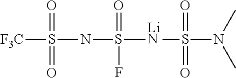

More specifically, the synthetic route to lithium (N,N-dimethylsulfamoyl)(S-fluoro-N-((trifluoromethyl)sulfonyl)sulfonimidoyl)amide is illustrated in the scheme below.

Trifluoromethanesulfonylamide dipotassium salt was obtained by reacting potassium tertbutoxide, KOtBu (7.6 g, 2.5 eq., 68.1 mmol) with trifluoromethanesulfonamide (4.8 g, 32.4 mmol) in THF (70 mL) under reflux for 16 h. The obtained white solid was filtered and washed with abundant THF to yield pure dipotassium salt (6.6 g, 29.2 mmol).

A solution of N-(sulfinyl) N,N-dimethylsulfonamide (0.31 g, 1.8 mmol), obtained as described in Journal of Fluorine Chemistry, 60 (1993) 283-288, in THF (2.2 mL) was added to a suspension of trifluoromethanesulfonylamide dipotassium salt (0.69 g, 1.5 eq, 2.7 mmol) in THF (2.2 mL) at −20° C. The mixture was stirred and allowed to reach room temperature until complete conversion was achieved as confirmed by ¹⁹F-NMR. A mixture of THF:HFIP (hexafluoro-2-propanol) 6.5:1 (12.1 mL) was added followed by 1-chloromethyl-4-fluoro-1,4-diazoniabicyclo[2.2.2]octane bis(tetrafluoroborate) (0.96 g, 1.5 eq, 2.7 mmol), also called F-TEDA. The reaction mixture was stirred until no further evolution was observed by ¹⁹F-NMR. Then, the solvent was removed under reduced pressure to yield an oil. This oil was taken into water (10 mL) and acidified with H2SO4. The aqueous solution was extracted with diethyl ether (3×15 mL), organic fractions were combined, and solvent was removed under reduced pressure. An aqueous solution of the obtained acid, N—(((N,N-dimethylsulfamoyl)amino)fluoro(oxo)-λ6-sulfaneylidene)-1,1,1-trifluoromethanesulfonamide, was treated with lithium carbonate (0.07 g, 0.5 eq., 0.9 mmol) and the reaction mixture stirred for 16 h at room temperature. Then solvent was removed in vacuo to yield a white solid. Excess of lithium carbonate was removed by selective dissolution of impurities and recrystallization from acetonitrile. Solvent was removed in vacuo to yield the lithium salt as a white-off powder. ¹H-NMR (300 MHz, MeCN-d3) δ (ppm) 2.81 (s, 6H, CH₃); ¹⁹F-NMR (283 MHz, MeCN-d3) δ (ppm) 69.1-69.0 (m, 1F, F), −79.2 (d, J=3.2 Hz, 3F, CF₃).

### Example 3: Preparation of the Solid Electrolytes

Solid polymer electrolytes (SPEs) with an average thickness of 100 m were prepared by conventional solvent casting method, followed by hot-pressing (high temperature film maker controller, Specac). LisFTFSI/PEO electrolyte was prepared by dissolving the corresponding lithium salt 1 and PEO in acetonitrile. LiTFSI/PEO and LisTFSI/PEO electrolytes used for comparison purposes were prepared according to reported procedures (LisTFSI: ChemElectrochem 2021, 8, 1322-1328; LiTFSI: Electrochim. Acta 2014, 133, 529-538). The concentration of the lithium salt was kept constant at a molar ratio of 20:1 (—CH₂CH₂O-(EO)/Li⁺) in all cases (herein EO means ethylene oxide).

### Example 4. Measurement of Ionic Conductivity

The ionic conductivity of the SPEs was determined by alternating-current (AC) impedance spectroscopy using a BT lab® potentiostat (Bio-Logic Science Instruments) in the frequency range from 10⁶ to 10⁻¹ Hz, at a variable temperature from 30 to 100° C. CR2032 type coin cells were assembled in an argon-filled glovebox using two stainless steel disks (SS) as blocking electrodes (SS|SPE|SS).

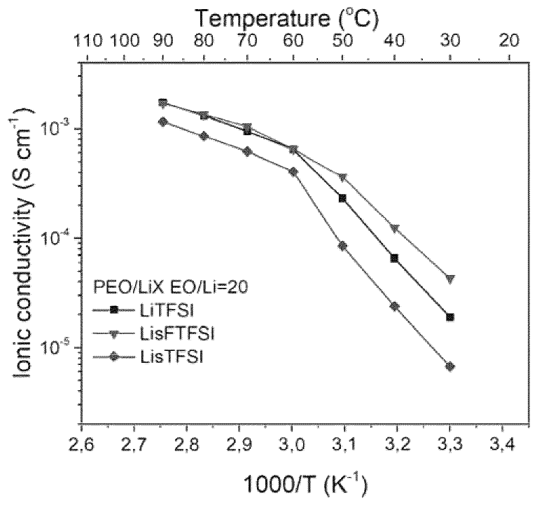

Salt 1-based electrolyte showed higher ionic conductivity than state-of-art polymer electrolytes at temperatures below 60° C. (see FIG. 1). Furthermore, Salt 1-based electrolyte showed higher ionic conductivity than LisTFSI/PEO electrolyte across the whole range of temperature studied evidencing the beneficial effect of the fluorine substituent at one of the sulfur atoms of the anion with a highly delocalized structure.

1. A solid polymer electrolyte comprising a compound of formula I 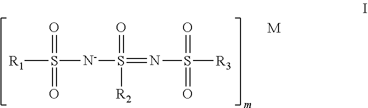
wherein
M is:
a proton;
a metal cation having a valency equal to 1, 2 or 3, chosen from ions of alkali metals, of alkaline earth metals, of transition metals or of rare-earth metals;
an organic onium or polyonium cation;
an organometallic cation;
m is an integer positive number; and
at least one of the groups R₁, R₂ or R₃ is F and the remainder is independently selected from:
Y, wherein Y represents:
an organic radical chosen from alkyl, alkenyl, alkynyl, aryl, alkylaryl, arylalkyl, alkylene oxide or alkylene imine, optionally substituted with at least a substituent selected from the group consisting of F, Cl, Br, I, —CN, —OR′, —SR′, —NR′₂, wherein R′ is H, alkyl, alkylene oxide or alkylene imine; or
a polymeric group comprising repeating units selected from alkylene oxide, alkylene imine, styrene, acrylate, maleimide, phosphazene, siloxane, vinyl alcohol, vinyl amine or mixtures thereof;
OY, —SY, —NY₂, wherein Y represents:
H or an organic radical chosen from alkyl, alkenyl, alkynyl, aryl, alkylaryl, arylalkyl, alkylene oxide or alkylene imine, optionally substituted with at least a substituent selected from the group consisting of F, Cl, Br, I, —CN, —OR′, —SR′, —NR′₂, wherein R′ is H, alkyl, alkylene oxide or alkylene imine; or
a polymeric group comprising repeating units selected from alkylene oxide, alkylene imine, styrene, acrylate, maleimide, phosphazene, siloxane, vinyl alcohol, vinyl amine or mixtures thereof.

2. The solid polymer electrolyte according to claim 1, wherein M is Li⁺.

3. The solid polymer electrolyte according to claim 1, wherein M is an onium cation selected from the group consisting of ammonium, guanidinium, amidinium, pyridinium, imidazolium, imidazolinium, triazolium, phosphonium, sulfonium and iodonium ions, or a polyonium cation selected from the group consisting of polyammonium, polyphosphonium, polypyridinium, polypyrrolidonium, polyimidazolium, polyimidazolinium and polysulfonium cations.

4. The solid polymer electrolyte according to claim 1, wherein at least one of the groups R₁, R₂ or R₃ is F and the remainder is independently selected from —Y.

5. The solid polymer electrolyte according to claim 1, wherein Y represents an organic radical chosen from fluorinated or perfluorinated alkyl.

6. The solid polymer electrolyte according to claim 1, wherein at least one of the groups R₁, R₂ or R₃ is F and the remainder is independently selected from —OY and/or —NY₂.

7. The solid polymer electrolyte according to claim 1, wherein Y is alkyl, alkenyl, alkynyl or alkylene oxide.

8. The solid polymer electrolyte according to claim 1, wherein at least one of the groups R₁, R₂ or R₃ is F and Y is a polymeric group comprising repeating units selected from alkylene oxide, alkylene imine, acrylate, maleimide, phosphazene, siloxane, vinyl alcohol, vinyl amine or mixtures thereof.

9. The solid polymer electrolyte according to claim 1, wherein at least one of the groups R₁, R₂ or R₃ is F and Y is a polymeric group comprising repeating units selected from alkylene oxide, acrylate or maleimide repeating units or mixtures thereof.

10. The solid polymer electrolyte according to claim 1, wherein R₂ is F.

11. The solid polymer electrolyte according to claim 1, where the solid polymer electrolyte comprises a conductive polymer.

12. The solid polymer electrolyte according to claim 11, wherein the conductive polymer is poly(ethylene oxide).

13. The solid polymer electrolyte according to claim 11, wherein when Y represents a polymeric group, said polymeric group is the conductive polymer comprised in the solid polymer electrolyte.

14. A secondary electrochemical cell or a secondary battery comprising the solid polymer electrolyte according to claim 1.

15. A vehicle, an electronic device, or an electrical grid comprising at least one of the secondary electrochemical cell or the secondary battery according to claim 14.
